(19) United States
(12) Patent Application Publication
(10) Pub. No.: US 2026/0110979 A1
(43) Pub. Date: Apr. 23, 2026

(54) PROCESS CARTRIDGE AND ELECTROPHOTOGRAPHIC APPARATUS

(71) Applicant: CANON KABUSHIKI KAISHA, Tokyo (JP)

(72) Inventors: CHIHARU AKIYAMA, Shizuoka (JP); AKIHIRO MARUYAMA, Shizuoka (JP); FUMIYUKI HIYAMA, Shizuoka (JP); TSUTOMU NISHIDA, Shizuoka (JP)

(21) Appl. No.: 19/348,683

(22) Filed: Oct. 2, 2025

(30) Foreign Application Priority Data
Oct. 17, 2024 (JP) 2024-182208

(51) Int. Cl. G03G 5/05; C08G 63/193; C08G 63/672; G03G 5/06; G03G 15/08; G03G 21/18

(52) U.S. Cl. CPC G03G 5/056; C08G 63/193; C08G 63/672; G03G 5/0609; G03G 15/0808; G03G 21/1814; G03G 2215/00957; G03G 2215/00962

(57) ABSTRACT

An electrophotographic apparatus includes an electrophotographic photosensitive member and a contact developing device including toner and a developing roller and configured to bring the developing roller carrying the toner into contact with the electrophotographic photosensitive member to develop an electrostatic latent image formed on a surface of the electrophotographic photosensitive member. The electrophotographic photosensitive member includes a surface layer containing a binder resin and an electron transport agent. The surface layer contains a polyester resin as the binder resin. The polyester resin includes a structural unit represented by formula (P-1) and a structural unit represented by formula (P-2). The developing roller includes a surface layer containing a compound represented by formula (1).

### BACKGROUND

### Field of the Technology

The present disclosure relates to an electrophotographic photosensitive member, a process cartridge and an electrophotographic apparatus including the electrophotographic photosensitive member.

### Description of the Related Art

In recent years, the longevity of electrophotographic apparatuses has been enhanced. However, in the electrophotographic process, extended service life, that is, long-term use tends to cause various adverse effects. Accordingly, various measures have been taken to address the various adverse effects.

Among such adverse effects, when the developing roller and the photosensitive member are kept in contact with each other for a long term, a quaternary ammonium salt (NR₄)⁺X⁻ serving as an ionic conductive agent used as a resistance control agent bleeds out and contaminates the contacting member. In particular, when the photosensitive member in contact with the developing roller is contaminated, the contact area is partially deteriorated, which may result in band-like image unevenness (referred to as “band-shaped image failure”).

In order to address such adverse effects, the configuration of developing rollers has been improved.

Japanese Patent Laid-Open No. 2009-58741 describes a conductive member used for an electrophotographic apparatus and containing a matrix polymer, conductive particles that conduct electrons, and a quaternary ammonium salt having a number-average molecular weight of 1000 or more. The conductive member has appropriate conductivity and suppresses occurrence of image failure due to bleeding of the quaternary ammonium salt.

Japanese Patent Laid-Open No. 2012-42574 describes a developing roller containing a silicone elastic layer, a urethane resin, a quaternary ammonium salt (NR₄)⁺X⁻ and acrylic resin particles. The particle size of the acrylic resin particles and the contents of the urethane resin, the quaternary ammonium salt, and the acrylic resin particles are appropriately set, to thereby prevent bleeding out of silicone oligomers. In addition, the time constant (the potential relaxation time of the developing roller) is reduced to thereby provide solid images having small density variation.

### SUMMARY

The present inventors studied the technique described in Japanese Patent Laid-Open No. 2012-42574 and have found that, when the developing roller and the photosensitive member are in contact with each other at high temperature and high humidity for a long period of time, the quaternary ammonium salt serving as the ionic conductive agent bleeds out to contaminate the contact portion of the photosensitive member in some cases. This results in an image failure called “band-shaped image failure” in some cases. In particular, when the surface layer of the photosensitive member contains an electron transport agent, contamination of the photosensitive member deteriorates electrical characteristics during durability testing, resulting in an image failure called “low density” in which the solid image density becomes lower after durability testing.

Accordingly, the present disclosure is directed to an electrophotographic apparatus that suppresses contamination of the photosensitive member due to bleeding of the ionic conductive agent and the resultant occurrence of image failure.

The present disclosure is directed to the following techniques. Specifically, an electrophotographic apparatus according to the present disclosure is:
an electrophotographic apparatus including:
an electrophotographic photosensitive member; and a contact developing device including toner and a developing roller and configured to bring the developing roller carrying the toner into contact with the electrophotographic photosensitive member to develop an electrostatic latent image formed on a surface of the electrophotographic photosensitive member,
wherein the electrophotographic photosensitive member includes a surface layer containing a binder resin and an electron transport agent,
wherein the surface layer contains a polyester resin as the binder resin,
wherein the polyester resin includes a structural unit represented by formula (P-1) and a structural unit represented by formula (P-2), and
wherein the developing roller includes a surface layer containing a compound represented by formula (1):

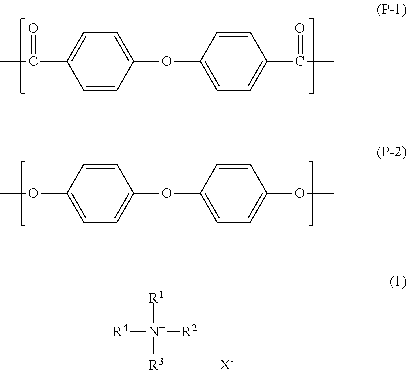

in the formula (1), R¹ to R⁴ represent a hydrocarbon group having 1 or more and 18 or less carbon atoms and at least one of R¹ to R⁴ represents a hydrocarbon group having 4 or more and 18 or less carbon atoms, and X⁻ represents an anion.

A process cartridge according to the present disclosure is:
a process cartridge including:
   an electrophotographic photosensitive member; and
   a contact developing device including toner and a developing roller and configured to bring the developing roller carrying the toner into contact with the electrophotographic photosensitive member to develop an electrostatic latent image formed on a surface of the electrophotographic photosensitive member,
   the process cartridge collectively supporting the electrophotographic photosensitive member and the contact developing device, and being attachable to and detachable from a body of an electrophotographic apparatus,
   wherein the electrophotographic photosensitive member includes a surface layer containing a binder resin and an electron transport agent,
   wherein the surface layer contains a polyester resin as the binder resin,
   wherein the polyester resin includes a structural unit represented by formula (P-1) and a structural unit represented by formula (P-2), and
   wherein the developing roller includes a surface layer containing a compound represented by formula (1):

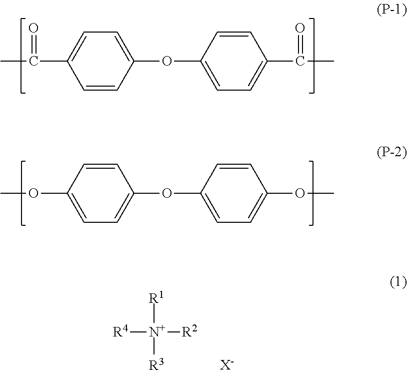

in the formula (1), R¹ to R⁴ represent a hydrocarbon group having 1 or more and 18 or less carbon atoms and at least one of R¹ to R⁴ represents a hydrocarbon group having 4 or more and 18 or less carbon atoms, and X⁻ represents an anion.

Features of the present disclosure will become apparent from the following description of embodiments with reference to the attached drawings. The following description of embodiments is described by way of example.

### BRIEF DESCRIPTION OF THE DRAWINGS

FIG. 1 illustrates an example of the layer configuration of a developing roller according to the present disclosure.

FIG. 2 illustrates an example of the schematic configuration of an electrophotographic apparatus including a process cartridge including an electrophotographic photosensitive member according to the present disclosure.

### DESCRIPTION OF THE EMBODIMENTS

Hereinafter, the techniques of the present disclosure will be described in detail with reference to preferred embodiments.

In an electrophotographic apparatus in which the developing roller includes an ionic conductive agent, particularly when the developing roller and the photosensitive member are in contact with each other at high temperature and high humidity for a long period of time, a quaternary ammonium salt serving as the ionic conductive agent bleeds out to contaminate the photosensitive member in some cases. This results in occurrence of an image failure called “band-shaped image failure” in some cases. The quaternary ammonium salt may be represented by (NR₄)⁺X⁻. The quaternary ammonium salt tends to be attracted electrostatically and tends to be attracted to the photosensitive member surface when there is an electrical bias on the surface, so that the ionic conductive agent tends to contaminate the photosensitive member. As inferred by the present inventors, when an electron transport agent is present in the near-surface region of the photosensitive member, the ionic conductive agent attacks the electron transport agent to cause deterioration of electrical characteristics, resulting in an image failure called “low density” in which the solid image density becomes lower after durability testing.

Accordingly, the present inventors studied the combination of the ionic conductive agent and the material of the surface of the photosensitive member and, as a result, have found that the following features can address the above-described disadvantage.

The present inventors have found that an electrophotographic apparatus including an electrophotographic photosensitive member and a contact developing device including toner and a developing roller and configured to bring the developing roller carrying the toner into contact with the electrophotographic photosensitive member to develop an electrostatic latent image formed on a surface of the electrophotographic photosensitive member,
wherein the electrophotographic photosensitive member includes a surface layer containing a binder resin and an electron transport agent, the surface layer contains a polyester resin as the binder resin, the polyester resin includes a structural unit represented by a formula (P-1) below and a structural unit represented by a formula (P-2) below, and the developing roller includes a surface layer containing a compound represented by a formula (1) below, can suppress contamination of the photosensitive member due to bleeding of the ionic conductive agent and the resultant occurrence of image failure.

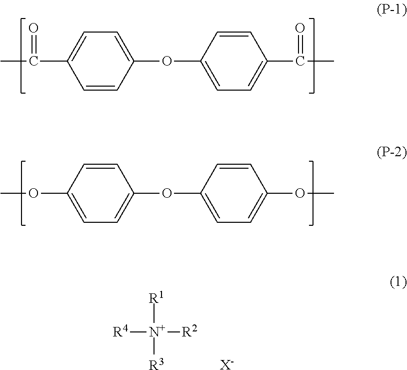

In the formula (1), R¹ to R⁴ represent a hydrocarbon group having 1 or more and 18 or less carbon atoms, and at least one of R¹ to R⁴ represents a hydrocarbon group having 4 or more and 18 or less carbon atoms. X⁻ represents an anion.

The present inventors consider that such features address the above-described disadvantage by the following mechanism.

The surface layer of the electrophotographic photosensitive member includes a polyester resin including the structural units represented by the formula (P-1) and the formula (P-2) and the ionic conductive agent has a structure represented by the formula (1). The ionic conductive agent represented by the formula (1) has a structure that has high compatibility with the developing roller and is less likely to bleed out. Furthermore, the polyester resin represented by the formulas (P-1) and (P-2) includes a large number of identical structures, mainly the ether bond, so that it has a structure having low electrical bias and reduced tendency to attract the ionic conductive agent and hence can suppress its bleeding.

The polyester resin has the ether structure and hence has high packing property and high density; thus, the present inventors have inferred that the polyester resin prevents the attack of the ionic conductive agent to the electron transport agent present particularly in the near-surface region of the photosensitive member. The present inventors have also inferred that the polyester resin suppresses deterioration of electrical characteristics and prevents occurrence of an image failure called “low density” in which the solid image density becomes lower after durability testing.

Hereinafter, the configuration of a photosensitive member used for an electrophotographic apparatus according to the present disclosure will be described in detail.

### Electrophotographic Photosensitive Member

The photosensitive member used for the electrophotographic apparatus according to the present disclosure includes a surface layer containing a polyester resin including a structural unit represented by the following formula (P-1) and a structural unit represented by the following formula (P-2).

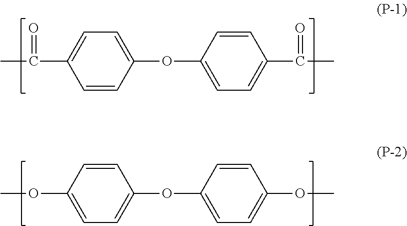

The method for producing the electrophotographic photosensitive member according to the present disclosure may be a method of preparing coating solutions of layers described later, applying the coating solutions in the desired order of the layers, and drying the coating solutions. In this case, examples of the process of applying the coating solutions include dip coating, spray coating, ink jet coating, roll coating, die coating, blade coating, curtain coating, wire bar coating, and ring coating. Of these, from the viewpoint of efficiency and productivity, preferred is dip coating.

Hereinafter, the support and the layers will be described.

### Support of Electrophotographic Photosensitive Member

The electrophotographic photosensitive member includes a support. In the present disclosure, the support is preferably a conductive support having conductivity. The support may have the shape of, for example, a cylinder, a belt, or a sheet. In particular, the support is preferably a cylindrical support. The surface of the support may be subjected to an electrochemical treatment such as anodization, a blasting treatment, a grinding treatment, or the like.

The support is preferably formed of a material such as a metal, a resin, or glass.

Examples of the metal include aluminum, iron, nickel, copper, gold, stainless steel, and alloys of the foregoing. In particular, preferred is an aluminum support formed of aluminum.

The resin and glass may be provided with conductivity by a treatment such as mixing of or coating with a conductive material.

### Conductive Layer of Electrophotographic Photosensitive Member

In the photosensitive member, a conductive layer may be disposed on the support. The conductive layer can conceal scratches and irregularities in the surface of the support and can control reflection of light by the surface of the support.

The conductive layer preferably contains conductive particles and a binder resin.

The material of the conductive particles may be, for example, a metal oxide, a metal, or carbon black.

Examples of the metal oxide include zinc oxide, aluminum oxide, indium oxide, silicon oxide, zirconium oxide, tin oxide, titanium oxide, magnesium oxide, antimony oxide, and bismuth oxide. Examples of the metal include aluminum, nickel, iron, nichrome, copper, zinc, and silver.

In particular, the conductive particles are preferably formed of a metal oxide, in particular, more preferably titanium oxide, tin oxide, or zinc oxide.

When the conductive particles are formed of a metal oxide, their metal oxide surfaces may be treated with a silane coupling agent or the like or the metal oxide may be doped with an element such as phosphorus or aluminum or an oxide of the foregoing.

The conductive particles may have a multilayer configuration including a core particle and a surface layer covering the particle. The core particle may be formed of titanium oxide, barium sulfate, zinc oxide, or the like.

The surface layer may be formed of a metal oxide such as tin oxide.

When the conductive particles are formed of a metal oxide, they have a volume-average particle size of preferably 1 nm or more and 500 nm or less, more preferably 3 nm or more and 400 nm or less.

Examples of the binder resin include polyester resins, polycarbonate resins, polyvinyl acetal resins, acrylic resins, silicone resins, epoxy resins, melamine resins, polyurethane resins, phenol resins, and alkyd resins.

The conductive layer may further contain silicone oil, resin particles, a hiding agent such as titanium oxide, or the like.

The conductive layer has an average thickness of preferably 1 μm or more and 50 μm or less, particularly preferably 3 μm or more and 40 μm or less.

The conductive layer can be formed by preparing a conductive layer-forming coating solution containing the above-described materials and a solvent, using it to form a coating film, and drying the coating film. Examples of the solvent used for the coating solution include alcohol-based solvents, sulfoxide-based solvents, ketone-based solvents, ether-based solvents, ester-based solvents, and aromatic hydrocarbon-based solvents. The process of dispersing the conductive particles in the conductive layer-forming coating solution may be a process of using a paint shaker, a sand mill, a ball mill, or a liquid-collision-type high-speed disperser.

### Undercoat Layer of Electrophotographic Photosensitive Member

In the photosensitive member used for the present disclosure, an undercoat layer may be disposed on the support or the conductive layer. When the undercoat layer is disposed, the interlayer adhesion can be enhanced and a function of blocking charge injection can be imparted.

The undercoat layer preferably contains a binder resin. A composition containing a monomer having a polymerizable functional group may be polymerized to thereby form a cured film serving as the undercoat layer.

Examples of the binder resin include polyester resins, polycarbonate resins, polyvinyl acetal resins, acrylic resins, epoxy resins, melamine resins, polyurethane resins, phenol resins, polyvinylphenol resins, alkyd resins, polyvinyl alcohol resins, polyethylene oxide resins, polypropylene oxide resins, polyamide resins, polyamic acid resins, polyimide resins, polyamide-imide resins, and cellulose resins.

For the monomer having a polymerizable functional group, the polymerizable functional group may be an isocyanate group, a blocked isocyanate group, a methylol group, an alkylated methylol group, an epoxy group, a metal alkoxide group, a hydroxyl group, an amino group, a carboxyl group, a thiol group, a carboxylic anhydride group, a carbon-carbon double bond group, or the like.

The undercoat layer may further contain an electron transport agent, a metal oxide, a metal, a conductive polymer, or the like in order to enhance electrical characteristics. Of these, the electron transport agent and the metal oxide are preferably used.

Examples of the electron transport agent include quinone compounds, imide compounds, benzimidazole compounds, cyclopentadienylidene compounds, fluorenone compounds, xanthone compounds, benzophenone compounds, cyanovinyl compounds, halogenated aryl compounds, silole compounds, and boron-containing compounds. An electron transport agent having a polymerizable functional group may be used as the electron transport agent and copolymerized with the above-described monomer having a polymerizable functional group to thereby form a cured film serving as the undercoat layer.

Examples of the metal oxide include indium tin oxide, tin oxide, indium oxide, titanium oxide, zinc oxide, aluminum oxide, and silicon dioxide. Examples of the metal include gold, silver, and aluminum.

The undercoat layer may further contain an additive.

The undercoat layer has an average thickness of preferably 0.1 μm or more and 50 μm or less, more preferably 0.2 μm or more and 40 μm or less, particularly preferably 0.3 μm or more and 30 μm or less.

The undercoat layer can be formed by preparing an undercoat layer-forming coating solution containing the above-described materials and a solvent, using it to form a coating film, and drying and/or curing the coating film. Examples of the solvent used for the coating solution include alcohol-based solvents, ketone-based solvents, ether-based solvents, ester-based solvents, and aromatic hydrocarbon-based solvents.

### Photosensitive Layer of Electrophotographic Photosensitive Member

The photosensitive layer of the photosensitive member is broadly divided into (1) a multilayer photosensitive layer and (2) a single-layer photosensitive layer. The multilayer photosensitive layer (1) includes a charge generation layer containing a charge generation agent and a charge transport layer containing a charge transport agent. The single-layer photosensitive layer (2) includes a photosensitive layer containing both of a charge generation agent and a charge transport agent.

### (1) Multilayer Photosensitive Layer

The multilayer photosensitive layer includes a charge generation layer and a charge transport layer.

### (1-1) Charge Generation Layer

The charge generation layer preferably contains a charge generation agent and a binder resin.

Examples of the charge generation agent include azo pigments, perylene pigments, polycyclic quinone pigments, indigo pigments, and phthalocyanine pigments. Of these, preferred are azo pigments and phthalocyanine pigments. Of the phthalocyanine pigments, preferred are oxytitanium phthalocyanine pigments, chlorogallium phthalocyanine pigments, and hydroxygallium phthalocyanine pigments.

In the charge generation layer, the content of the charge generation agent relative to the total mass of the charge generation layer is preferably 40 mass % or more and 85 mass % or less, more preferably 60 mass % or more and 80 mass % or less.

Examples of the binder resin include polyester resins, polycarbonate resins, polyvinyl acetal resins, polyvinyl butyral resins, acrylic resins, silicone resins, epoxy resins, melamine resins, polyurethane resins, phenol resins, polyvinyl alcohol resins, cellulose resins, polystyrene resins, polyvinyl acetate resins, and polyvinyl chloride resins.

Of these, more preferred are polyvinyl butyral resins.

The charge generation layer may further contain additives such as an antioxidant and an ultraviolet absorber.

Specific examples include hindered phenol compounds, hindered amine compounds, sulfur compounds, phosphorus compounds, and benzophenone compounds.

The charge generation layer has an average thickness of preferably 0.1 μm or more and 1 μm or less, more preferably 0.15 μm or more and 0.4 μm or less.

The charge generation layer can be formed by preparing a charge generation layer-forming coating solution containing the above-described materials and a solvent, using it to form a coating film, and drying the coating film. Examples of the solvent used for the coating solution include alcohol-based solvents, sulfoxide-based solvents, ketone-based solvents, ether-based solvents, ester-based solvents, and aromatic hydrocarbon-based solvents.

### (1-2) Charge Transport Layer

The charge transport layer preferably contains a charge transport agent and a binder resin.

Examples of the charge transport agent include polycyclic aromatic compounds, heterocyclic compounds, hydrazone compounds, styryl compounds, enamine compounds, benzidine compounds, triaryl amine compounds, and resins having groups derived from the foregoing agents. Of these, preferred are triaryl amine compounds and benzidine compounds.

In the charge transport layer, the content of the charge transport agent relative to the total mass of the charge transport layer is preferably 25 mass % or more and 70 mass % or less, more preferably 30 mass % or more and 55 mass % or less.

Examples of the binder resin include polyester resins, polycarbonate resins, acrylic resins, and polystyrene resins. Of these, preferred are polycarbonate resins and polyester resins. The polyester resins are particularly preferably polyarylate resins.

The content ratio (mass ratio) of the charge transport agent and the binder resin is preferably 4:10 to 20:10, more preferably 5:10 to 12:10.

The charge transport layer may contain additives such as an antioxidant, an ultraviolet absorber, a plasticizer, a leveling agent, a slip agent, and a wear resistance improver. Specific examples include hindered phenol compounds, hindered amine compounds, sulfur compounds, phosphorus compounds, benzophenone compounds, siloxane modified resins, silicone oil, fluororesin particles, polystyrene resin particles, polyethylene resin particles, silica particles, alumina particles, and boron nitride particles.

The charge transport layer has an average thickness of preferably 5 μm or more and 50 μm or less, more preferably 8 μm or more and 40 μm or less, particularly preferably 10 μm or more and 30 μm or less.

The charge transport layer can be formed by preparing a charge transport layer-forming coating solution containing the above-described materials and a solvent, using it to form a coating film, and drying the coating film. Examples of the solvent used for the coating solution include alcohol-based solvents, ketone-based solvents, ether-based solvents, ester-based solvents, and aromatic hydrocarbon-based solvents. Of these solvents, preferred are ether-based solvents or aromatic hydrocarbon-based solvents.

When a protective layer described later is not disposed, the charge transport layer serves as the surface layer of the electrophotographic photosensitive member.

### (2) Single-Layer Photosensitive Layer

The photosensitive member used in the present disclosure preferably has a single-layer photosensitive layer containing a charge generation agent, a hole transport agent, an electron transport agent, and a binder resin.

Examples of the charge generation agent include phthalocyanine-based pigments, perylene-based pigments, bisazo pigments, trisazo pigments, dithioketopyrrolopyrrole pigments, metal-free naphthalocyanine pigments, metal naphthalocyanine pigments, squaraine pigments, indigo pigments, azulenium pigments, cyanine pigments, powders of inorganic photoconductive materials (such as selenium, selenium-tellurium, selenium-arsenic, cadmium sulfide, and amorphous silicon), pyrylium pigments, anthanthrone-based pigments, triphenylmethane-based pigments, threne-based pigments, toluidine-based pigments, pyrazoline-based pigments, and quinacridone-based pigments. The photosensitive layer may contain a single charge generation agent alone or two or more charge generation agents.

The phthalocyanine-based pigments are pigments having a phthalocyanine structure. Examples of the phthalocyanine-based pigments include metal-free phthalocyanines and metal phthalocyanines.

Examples of the metal phthalocyanines include titanyl phthalocyanine, hydroxygallium phthalocyanine, and chlorogallium phthalocyanine. Such a metal phthalocyanine is preferably titanyl phthalocyanine. The titanyl phthalocyanine is a compound represented by the following formula (CGM-1).

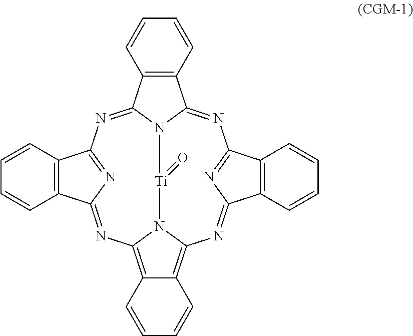

The phthalocyanine-based pigments may be crystalline or amorphous. Examples of the crystals of the metal-free phthalocyanines include X-type crystals of metal-free phthalocyanines (hereafter may be referred to as X-type metal-free phthalocyanines). Examples of the crystals of titanyl phthalocyanine include α-type crystals, β-type crystals, and Y-type crystals of titanyl phthalocyanine (hereafter may be respectively referred to as α-type titanyl phthalocyanine, β-type titanyl phthalocyanine, and Y-type titanyl phthalocyanine). For example, for a digital optical electrophotographic apparatus (such as a laser beam printer or a facsimile using a light source such as a semiconductor laser), a photosensitive member having sensitivity in a wavelength region of 700 nm or more is preferably used. Because of having a high quantum yield in the wavelength region of 700 nm or more, the charge generation agent is preferably phthalocyanine-based pigments, more preferably metal-free phthalocyanines or titanyl phthalocyanine, still more preferably titanyl phthalocyanine. Of these, particularly preferred is Y-type titanyl phthalocyanine.

The Y-type titanyl phthalocyanine has, in a CuKα characteristic X-ray diffraction spectrum, a main peak at, for example, a Bragg angle (2θ±0.2°) of 27.2°. The main peak in a CuKα characteristic X-ray diffraction spectrum is a peak having the largest or second largest intensity in the range of Bragg angles (2θ±0.2°) of 3° or more and 400 or less. The Y-type titanyl phthalocyanine does not have a peak at 26.2° in the CuKα characteristic X-ray diffraction spectrum.

The CuKα characteristic X-ray diffraction spectrum can be measured by, for example, the following method. First, a sample is packed into the sample holder of an X-ray diffractometer (such as “RINT (registered trademark) 1100” manufactured by Rigaku Corporation) and the X-ray diffraction spectrum is measured under conditions of an X-ray tube target of Cu, a tube voltage of 40 kV, a tube current of 30 mA, and a CuKα characteristic X-ray having a wavelength of 1.542 Å. The measurement range (2θ) is, for example, 3° or more and 400 or less (start angle: 3°, stop angle: 40°), and the scanning rate is, for example, 10°/min. In the obtained X-ray diffraction spectrum, the main peak is determined and the Bragg angle of the main peak is read.

The content of the charge generation agent relative to 100 parts by mass of the binder resin is preferably 0.1 parts by mass or more and 50 parts by mass or less, more preferably 0.5 parts by mass or more and 5 parts by mass or less.

The hole transport agent is preferably at least one selected from the group consisting of a compound represented by the following formula (10), a compound represented by the following formula (11), a compound represented by the following formula (12), a compound represented by the following formula (13), and a compound represented by the following formula (14). When the photosensitive layer contains the hole transport agent, the compatibility between the binder resin and the electron transport agent is enhanced and the internal uniformity of the photosensitive layer is enhanced, which inferentially enhances advantages of the technique of the present disclosure.

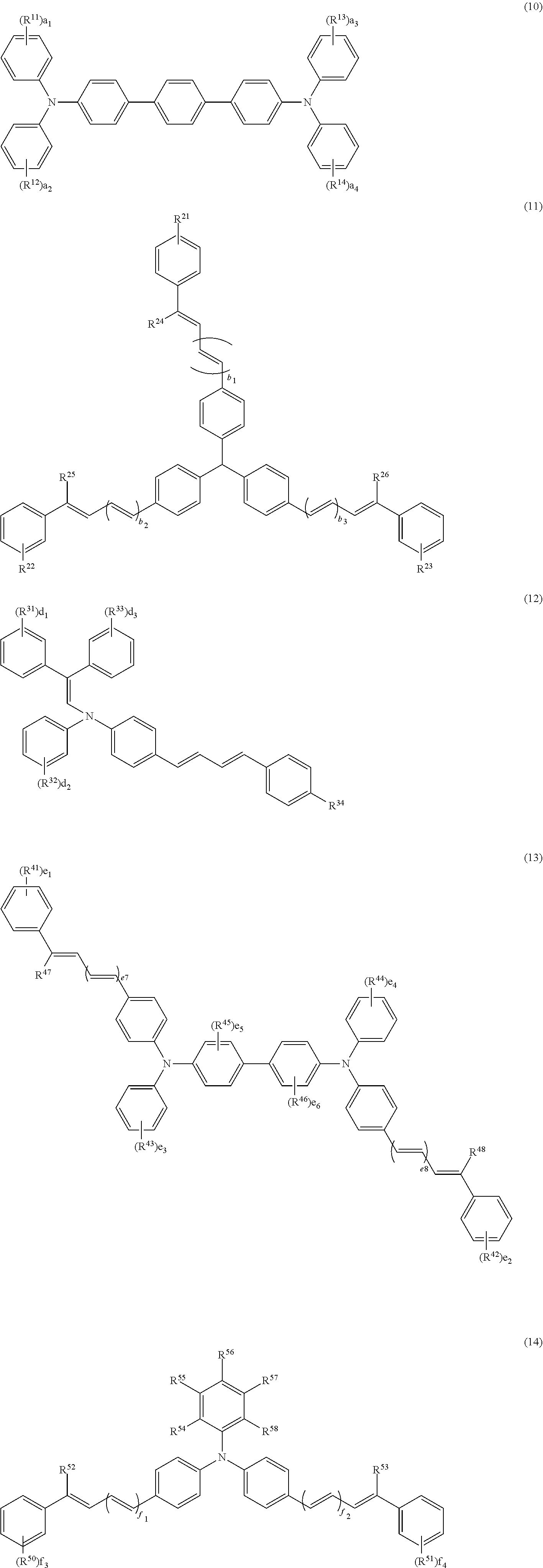

In the formula (10), R¹¹, R¹², R¹³, and R¹⁴ each independently represent an alkyl group having 1 or more and 6 or less carbon atoms or an alkoxy group having 1 or more and 6 or less carbon atoms. a₁, a₂, a₃, and a₄ each independently represent an integer of 0 or more and 5 or less. In the formula (10), when a₁ represents an integer of 2 or more and 5 or less, the plurality of R¹¹ may represent the same groups or may represent different groups. When a₂ represents an integer of 2 or more and 5 or less, the plurality of R¹² may represent the same groups or may represent different groups. When a₃ represents an integer of 2 or more and 5 or less, the plurality of R¹³ may represent the same groups or may represent different groups. When a₄ represents an integer of 2 or more and 5 or less, the plurality of R¹⁴ may represent the same groups or may represent different groups. In the formula (10), R¹¹, R¹², R¹³, and R¹⁴ each independently represent preferably an alkyl group having 1 or more and 3 or less carbon atoms, more preferably a methyl group or an ethyl group. a₁, a₂, a₃, and a₄ each independently represent preferably an integer of 1 or more and 3 or less, more preferably 1.

In the formula (11), R²¹, R²², and R²³ each independently represent an alkyl group having 1 or more and 6 or less carbon atoms. R²⁴, R²⁵, and R²⁶ each independently represent a hydrogen atom or an alkyl group having 1 or more and 6 or less carbon atoms. b₁, b₂, and b₃ each independently represent 0 or 1. In the formula (11), R²¹, R²², and R²³ each independently represent preferably an alkyl group having 1 or more and 3 or less carbon atoms, more preferably a methyl group. The bonding positions of R²¹, R²², and R²³ in the phenyl groups are preferably meta positions relative to the bonding positions of the phenyl groups to the triphenylamine structure. R²⁴, R²⁵, and R²⁶ each represent preferably a hydrogen atom. b₁, b₂, and b₃ each represent preferably 0 or 1.

In the formula (12), R³¹, R³², and R³³ each independently represent an alkyl group having 1 or more and 6 or less carbon atoms. R³⁴ represents an alkyl group having 1 or more and 6 or less carbon atoms or a hydrogen atom. d₁, d₂, and d₃ each independently represent an integer of 0 or more and 5 or less. In the formula (12), when d₁ represents an integer of 2 or more and 5 or less, the plurality of R³¹ may represent the same groups or may represent different groups. When d₂ represents an integer of 2 or more and 5 or less, the plurality of R³² may represent the same groups or may represent different groups. When d₃ represents an integer of 2 or more and 5 or less, the plurality of R³³ may represent the same groups or may represent different groups. In the formula (12), R³⁴ preferably represents a hydrogen atom. d₁, d₂, and d₃ each represent preferably 0.

In the formula (13), R⁴¹, R⁴², R⁴³, R⁴⁴, R⁴⁵, and R⁴⁶ each independently represent an alkyl group having 1 or more and 6 or less carbon atoms or a phenyl group. R⁴⁷ and R⁴⁸ each independently represent a hydrogen atom, an alkyl group having 1 or more and 6 or less carbon atoms, or a phenyl group.

e₁, e₂, e₃, and e₄ each independently represent an integer of 0 or more and 5 or less. e₅ and e₆ each independently represent an integer of 0 or more and 4 or less. e₇ and e₈ each independently represent 0 or 1. In the formula (13), when e₁ represents an integer of 2 or more and 5 or less, the plurality of R⁴¹ may represent the same groups or may represent different groups. When e₂ represents an integer of 2 or more and 5 or less, the plurality of R⁴² may represent the same groups or may represent different groups. When e₃ represents an integer of 2 or more and 5 or less, the plurality of R⁴³ may represent the same groups or may represent different groups. When e₄ represents an integer of 2 or more and 5 or less, the plurality of R⁴ may represent the same groups or may represent different groups. When e₅ represents an integer of 2 or more and 4 or less, the plurality of R⁴⁵ may represent the same groups or may represent different groups. When e₆ represents an integer of 2 or more and 4 or less, the plurality of R⁴⁶ may represent the same groups or may represent different groups. In the formula (13), R⁴¹ to R⁴⁶ each independently represent preferably an alkyl group having 1 or more and 6 or less carbon atoms, more preferably an alkyl group having 1 or more and 3 or less carbon atoms, still more preferably a methyl group or an ethyl group. R⁴⁷ and R⁴⁸ preferably represent a hydrogen atom. e₁, e₂, e₃, and e₄ each independently represent preferably an integer of 0 or more and 2 or less, and more preferably e₁ and e₂ represent 0 and e₃ and e₄ represent 2. e₅ and e₆ preferably represent 0. e₇ and e₈ each preferably represent 0 or 1.

In the formula (14), R⁵⁰ and R⁵¹ each independently represent an alkyl group having 1 or more and 6 or less carbon atoms, an alkoxy group having 1 or more and 6 or less carbon atoms, or a phenyl group. R⁵², R⁵³, R⁵⁴, R⁵⁵, R⁵⁶, R⁵⁷, and R⁵⁸ each independently represent a hydrogen atom, an alkyl group having 1 or more and 6 or less carbon atoms, an alkoxy group having 1 or more and 6 or less carbon atoms, or a phenyl group that may be substituted with an alkyl group having 1 or more and 6 or less carbon atoms. f₁ and f₂ each independently represent an integer of 0 or more and 2 or less. f₃ and f₄ each independently represent an integer of 0 or more and 5 or less. In the formula (14), when f₃ represents an integer of 2 or more and 5 or less, the plurality of R⁵¹ may represent the same groups or may represent different groups. When f₄ represents an integer of 2 or more and 5 or less, the plurality of R⁵¹ may represent the same groups or may represent different groups. In the formula (14), R⁵⁰ and R⁵¹ each independently represent preferably an alkyl group having 1 or more and 6 or less carbon atoms. R⁵² and R⁵³ each preferably represent a hydrogen atom or a phenyl group that may be substituted with an alkyl group having 1 or more and 6 or less carbon atoms. R⁵⁴ to R⁵⁸ each independently represent preferably a hydrogen atom, an alkyl group having 1 or more and 6 or less carbon atoms, or an alkoxy group having 1 or more and 6 or less carbon atoms. f₁ and f₂ each preferably represent 0, each preferably represent 1, or each preferably represent 2. f₃ and f₄ each independently represent preferably 0 or 1. When R⁵⁰ and R⁵¹ each represent an alkyl group having 1 or more and 6 or less carbon atoms, they preferably represent an alkyl group having 1 or more and 3 or less carbon atoms, more preferably a methyl group. When R⁵² and R⁵³ each represent a phenyl group that may be substituted with an alkyl group having 1 or more and 6 or less carbon atoms, they preferably represent a phenyl group or a phenyl group substituted with an alkyl group having 1 or more and 3 or less carbon atoms. The phenyl group substituted with an alkyl group having 1 or more and 3 or less carbon atoms is preferably a methylphenyl group, more preferably a 4-methylphenyl group. When R⁵⁴ to R⁵⁸ each represent an alkyl group having 1 or more and 6 or less carbon atoms, they preferably represent an alkyl group having 1 or more and 4 or less carbon atoms, preferably a methyl group, an ethyl group, or an n-butyl group. When R⁵⁴ to R⁵⁸ each represent an alkoxy group having 1 or more and 6 or less carbon atoms, they preferably represent an alkoxy group having 1 or more and 3 or less carbon atoms, more preferably an ethoxy group.

Preferred examples of the compound represented by the formula (10) include the compound represented by a formula (H-11). Preferred examples of the compound represented by the formula (11) include the compound represented by a formula (H-7) and the compound represented by a formula (H-8). Preferred examples of the compound represented by the formula (12) include the compound represented by a formula (H-6). Preferred examples of the compound represented by the formula (13) include the compound represented by a formula (H-9) and the compound represented by a formula (H-10). Preferred examples of the compound represented by the formula (14) include the compound represented by a formula (H-1), the compound represented by a formula (H-2), the compound represented by a formula (H-3), the compound represented by a formula (H-4), and the compound represented by a formula (H-5). Hereafter, the compounds represented by the formulas (H-2) to (H-11) may be respectively referred to as hole transport agents (H-2) to (H-11).

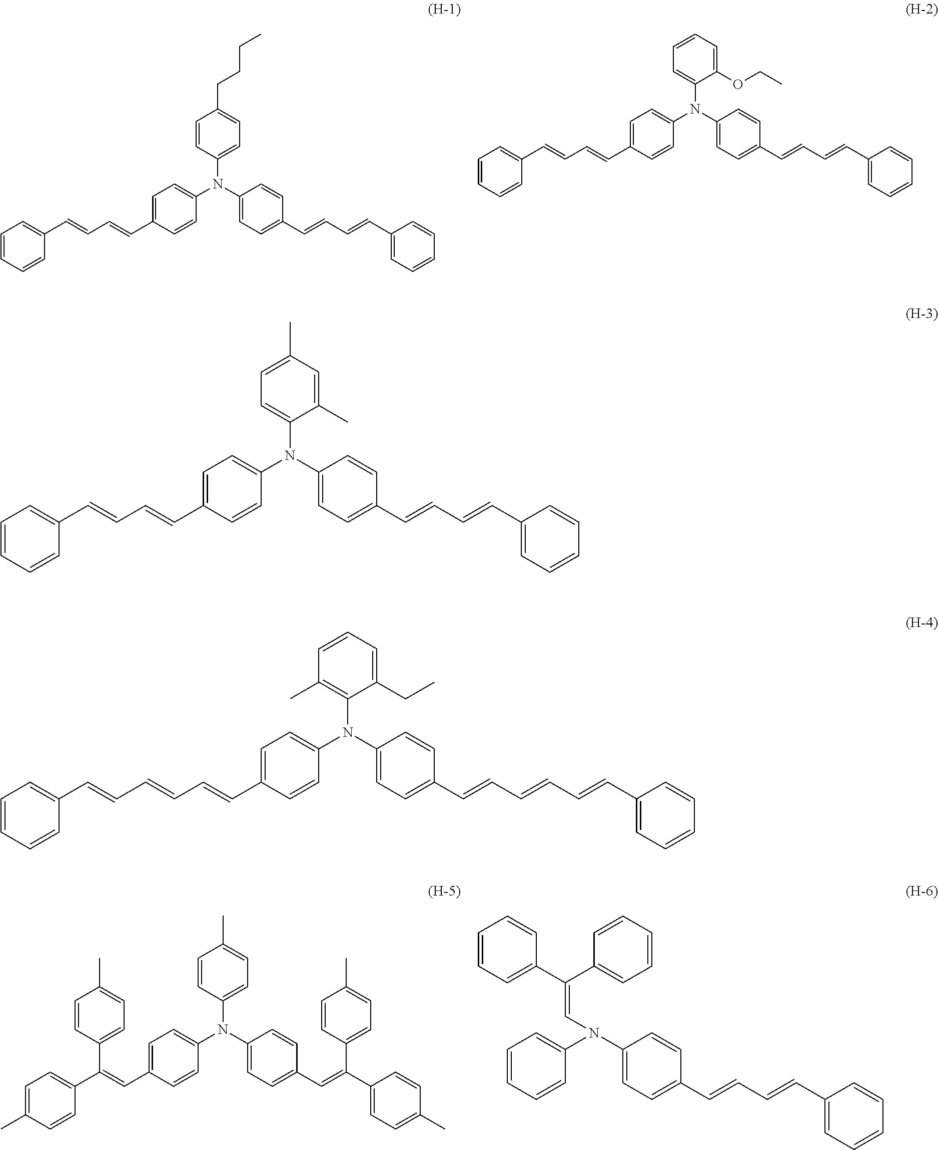

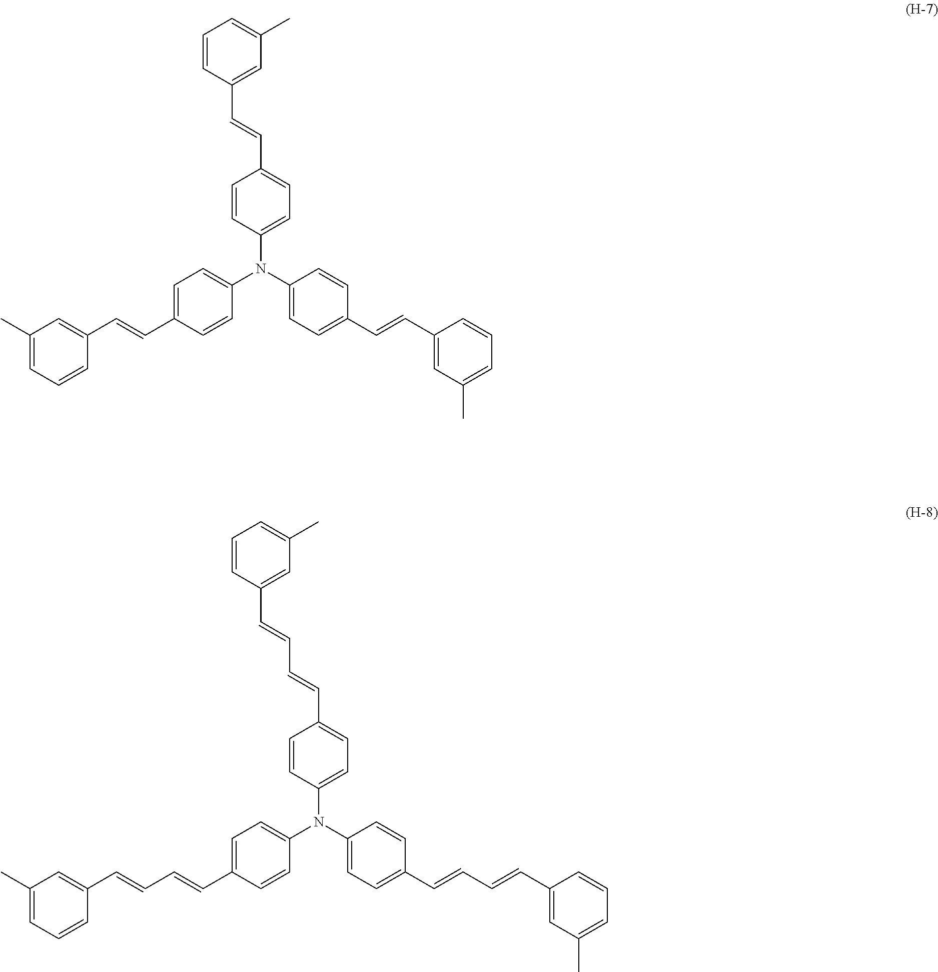 [SMILES: Cc1cccc(/C=C/c2ccc(N(c3ccc(/C=C/c4cccc(C)c4)cc3)c3ccc(/C=C/c4cccc(C)c4)cc3)cc2)c1 ; Cc1cccc(/C=C/C=C/c2ccc(N(c3ccc(/C=C/C=C/c4cccc(C)c4)cc3)c3ccc(/C=C/C=C/c4cccc(C)c4)cc3)cc2)c1]

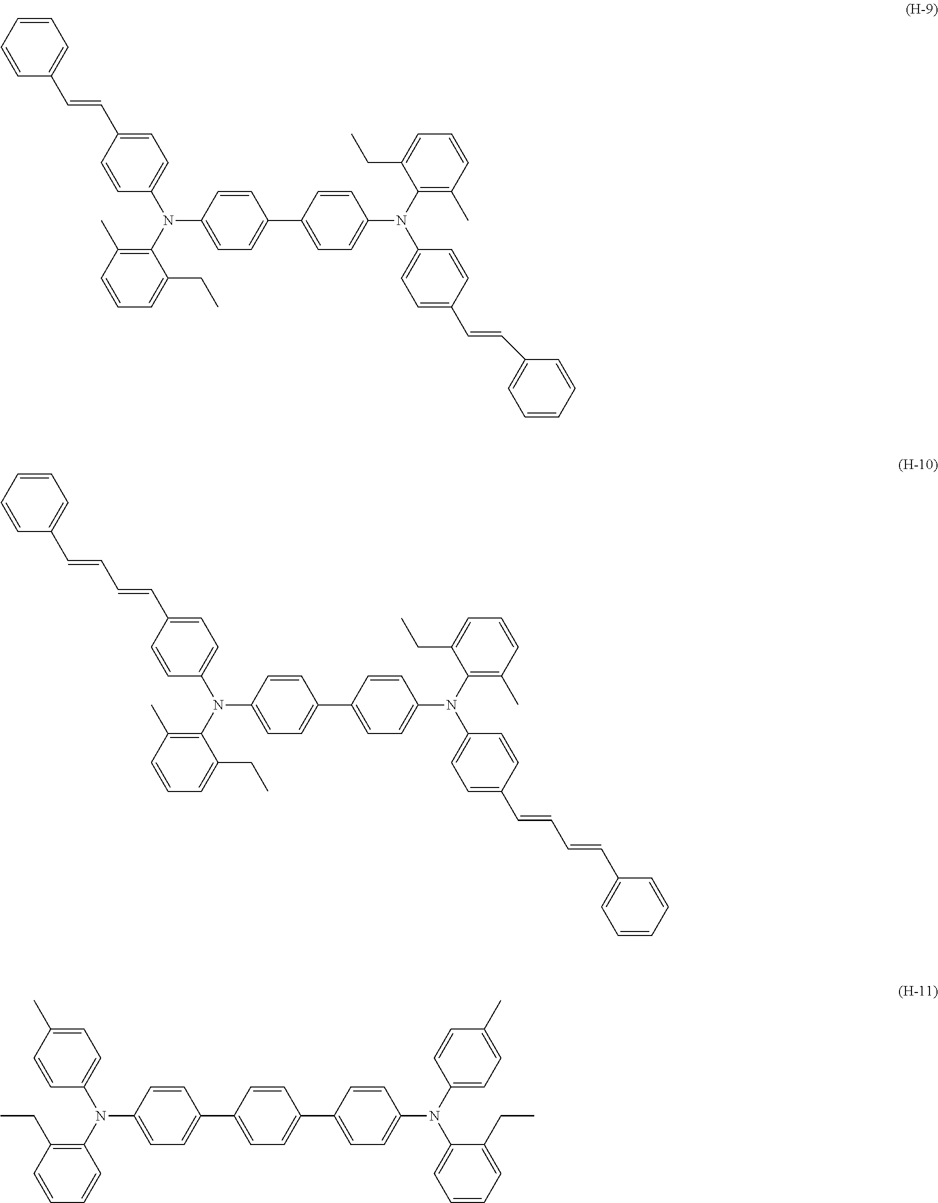 [SMILES: CCc1cccc(C)c1N(c1ccc(/C=C/c2ccccc2)cc1)c1ccc(-c2ccc(N(c3ccc(/C=C/c4ccccc4)cc3)c3c(C)cccc3CC)cc2)cc1 ; CCc1cccc(C)c1N(c1ccc(/C=C/C=C/c2ccccc2)cc1)c1ccc(-c2ccc(N(c3ccc(/C=C/C=C/c4ccccc4)cc3)c3c(C)cccc3CC)cc2)cc1 ; CCc1ccccc1N(c1ccc(C)cc1)c1ccc(-c2ccc(-c3ccc(N(c4ccc(C)cc4)c4ccccc4CC)cc3)cc2)cc1]

The content of the hole transport agent relative to 100 parts by mass of the binder resin is preferably 10 parts by mass or more and 200 parts by mass or less, more preferably 30 parts by mass or more and 120 parts by mass or less, still more preferably 50 parts by mass or more and 90 parts by mass or less. The photosensitive layer may contain a single hole transport agent alone or two or more hole transport agents. The photosensitive layer may further contain a hole transport agent other than the compounds represented by the formulas (10), (11), (12), (13), and (14) (hereafter also referred to as other hole transport agent). Examples of the other hole transport agent include triphenylamine derivatives, diamine derivatives (such as N,N,N′,N′-tetraphenylbenzidine derivatives, N,N,N′,N′-tetraphenylphenylenediamine derivatives, N,N,N′,N′-tetraphenylnaphthylenediamine derivatives, N,N,N′,N′-tetraphenylphenanthrylenediamine derivatives, and di(aminophenylethenyl)benzene derivatives), oxadiazole-based compounds (such as 2,5-di(4-methylaminophenyl)-1,3,4-oxadiazole), styryl-based compounds (such as 9-(4-diethylaminostyryl)anthracene), carbazole-based compounds (such as polyvinylcarbazole), organic polysilane compounds, pyrazoline-based compounds (such as 1-phenyl-3-(p-dimethylaminophenyl)pyrazoline), hydrazone-based compounds, indole-based compounds, oxazole-based compounds, isoxazole-based compounds, thiazole-based compounds, thiadiazole-based compounds, imidazole-based compounds, pyrazole-based compounds, and triazole-based compounds.

The electron transport agent and the binder resin are as described in the examples of the materials in the surface layer.

In the surface layer of the electrophotographic photosensitive member, the content of the binder resin defined as B parts by mass and the content of the electron transport agent defined as E parts by mass preferably satisfy the following formula (3).

$$20 \leq E / ( E + B ) \times 100 \leq 40 \qquad ( 3 )$$

When a protective layer described later is not disposed, the single-layer photosensitive layer serves as the surface layer of the electrophotographic photosensitive member.

### Protective Layer of Electrophotographic Photosensitive Member

A protective layer may be disposed on the photosensitive layer. The protective layer can enhance durability.

The protective layer preferably contains conductive particles and/or a charge transport agent and a binder resin.

The conductive particles may be particles of a metal oxide such as titanium oxide, zinc oxide, tin oxide, or indium oxide.

Examples of the charge transport agent include polycyclic aromatic compounds, heterocyclic compounds, hydrazone compounds, styryl compounds, enamine compounds, benzidine compounds, triaryl amine compounds, and resins having groups derived from the foregoing agents. Of these, preferred are triaryl amine compounds and benzidine compounds.

Examples of the binder resin include polyester resins, acrylic resins, phenoxy resins, polycarbonate resins, polystyrene resins, phenol resins, melamine resins, and epoxy resins. Of these, preferred are polycarbonate resins, polyester resins, and acrylic resins.

The protective layer may be formed as a cured film by polymerizing a composition containing a monomer having a polymerizable functional group. In this case, the reaction may be a thermal polymerization reaction, a photopolymerization reaction, a radiation polymerization reaction, or the like. For the monomer having a polymerizable functional group, the polymerizable functional group may be an acryloyl group, a methacryloyl group, or the like. The monomer having a polymerizable functional group may be a material having a charge transport capability.

The protective layer may contain an additive such as an antioxidant, an ultraviolet absorber, a plasticizer, a leveling agent, a slip agent, or a wear resistance improver. Specific examples include hindered phenol compounds, hindered amine compounds, sulfur compounds, phosphorus compounds, benzophenone compounds, siloxane modified resins, silicone oil, fluororesin particles, polystyrene resin particles, polyethylene resin particles, silica particles, alumina particles, and boron nitride particles.

The protective layer preferably has an average thickness of 0.5 μm or more and 10 μm or less, preferably 1 μm or more and 7 μm or less.

The protective layer can be formed by preparing a protective layer-forming coating solution containing the above-described materials and a solvent, using it to form a coating film, and drying and/or curing the coating film. Examples of the solvent used for the coating solution include alcohol-based solvents, ketone-based solvents, ether-based solvents, sulfoxide-based solvents, ester-based solvents, and aromatic hydrocarbon-based solvents.

When the protective layer is disposed, the protective layer serves as the surface layer of the electrophotographic photosensitive member.

### Surface Layer of Electrophotographic Photosensitive Member

The photosensitive member according to the present disclosure includes a surface layer containing an electron transport agent and a polyester resin including a structural unit represented by the following formula (P-1) and a structural unit represented by the following formula (P-2).

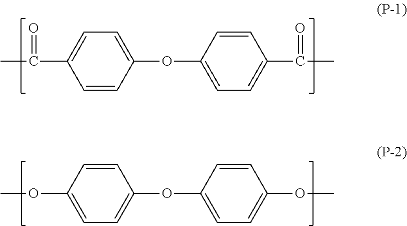

The surface layer used herein is a part of the photosensitive member that comes into contact with the developing roller and various members during the electrophotographic process, and the protective layer, the charge transport layer, or the single-layer photosensitive layer can serve as the surface layer.

The polyester resin preferably further contains a polyester resin including a structural unit represented by the following formula (P-3) and a structural unit represented by the following formula (P-4) from the viewpoint of solubility and suppression of bleeding of the ionic conductive agent.

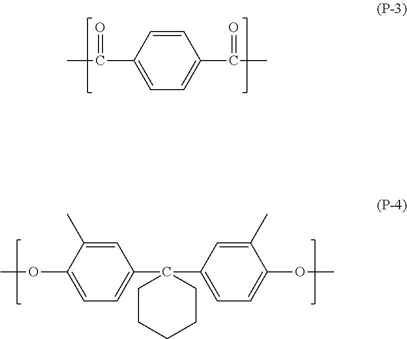

The chemical substances according to the technique of the present disclosure can be analyzed using a nuclear magnetic resonance (NMR) apparatus to determine the molecular structures.

The photosensitive layer may contain a resin other than the above-described polyester resins as long as it does not impair advantages of the technique of the present disclosure. Examples of the other resin include polycarbonate resins, styrene resins, acrylic resins, polyester resins other than those described above, and polyarylate resins.

The polyester resin may be, for example, a random copolymer, an alternating copolymer, a periodic copolymer, or a block copolymer.

The polyester resin preferably has a viscosity-average molecular weight of 10,000 or more, more preferably 30,000 or more, still more preferably 50,000 or more.

When the polyester resin has a viscosity-average molecular weight of 10,000 or more, wear resistance of the photosensitive member is improved. The polyester resin preferably has a viscosity-average molecular weight of 80,000 or less, more preferably 70,000 or less. When the polyester resin has a viscosity-average molecular weight of 80,000 or less, the polyester resin is easily dissolved in solvents for forming the photosensitive layer. The viscosity-average molecular weight can be determined by publicly known methods.

The bisphenols constituting the bisphenol-derived repeating units (the structural unit represented by the formula (P-2) and the structural unit represented by the formula (P-4)) may be, for example, the compound represented by a formula (BP-2) and the compound represented by a formula (BP-5). Hereafter, the compound represented by the formula (BP-2) will also be referred to as the compound (BP-2) and the compound represented by the formula (BP-5) will also be referred to as the compound (BP-5). The dicarboxylic acids constituting the dicarboxylic acid-derived repeating units (the structural unit represented by the formula (P-1) and the structural unit represented by the formula (P-3)) may be, for example, the compound represented by a formula (DC-1) and the compound represented by a formula (DC-4). Hereafter, the compound represented by the formula (DC-1) will also be referred to as the compound (DC-1) and the compound represented by the formula (DC-4) will also be referred to as the compound (DC-4). The amount of the compound (BP-5) and the amount of the compound (BP-2) added during production of the polyester resin (PAR) can be changed to thereby adjust the ratio of the bisphenols in the resin. Similarly for the amounts of dicarboxylic acids, the amount of the compound (DC-1) and the amount of the compound (DC-4) added during production can be changed to thereby adjust the ratio of the dicarboxylic acids in the resin.

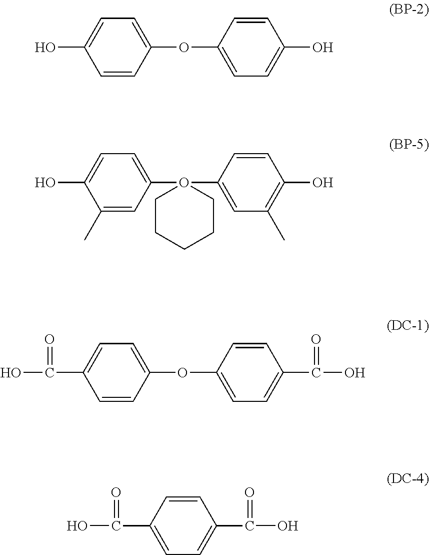

The bisphenols (such as the compound (BP-2) and the compound (BP-5)) may be turned into derivatives that are aromatic diacetates and used. The dicarboxylic acids (such as the compound (DC-1) and the compound (DC-4)) may be turned into derivatives and used. Examples of the derivatives of the dicarboxylic acids include dicarboxylic acid dichlorides, dicarboxylic dimethyl esters, dicarboxylic diethyl esters, and dicarboxylic anhydrides. The dicarboxylic acid dichlorides are compounds in which the two “—C(═O)—OH” groups of a dicarboxylic acid are each substituted with a “—C(═O)—Cl” group.

In the polycondensation of a bisphenol and a dicarboxylic acid, one or both of a base and a catalyst may be added. The base may be, for example, sodium hydroxide. The catalyst may be, for example, benzyltributylammonium chloride, ammonium chloride, ammonium bromide, quaternary ammonium salt, triethylamine, or trimethylamine.

The photosensitive layer may contain, as the binder resin, the polyester resin alone or may further contain another binder resin (hereafter also referred to as the other binder resin). Examples of the other binder resin include thermoplastic resins (more specifically polyester resins other than the above-described polyester resins, polycarbonate resins, styrene-based resins, styrene-butadiene copolymers, styrene-acrylonitrile copolymers, styrene-maleic acid copolymers, styrene-acrylic acid copolymers, acrylic copolymers, polyethylene resins, ethylene-vinyl acetate copolymers, chlorinated polyethylene resins, polyvinyl chloride resins, polypropylene resins, ionomers, vinyl chloride-vinyl acetate copolymers, polyester resins, alkyd resins, polyamide resins, polyurethane resins, polysulfone resins, diallyl phthalate resins, ketone resins, polyvinyl butyral resins, polyvinyl acetal resins, and polyether resins), thermosetting resins (more specifically, silicone resins, epoxy resins, phenol resins, urea resins, melamine resins, and other crosslinkable thermosetting resins), and photocurable resins (more specifically, epoxy-acrylic acid-based resins, and urethane-acrylic acid-based copolymers).

In the electrophotographic photosensitive member of the present disclosure, in the binder resin, the content of the resin at least including the structural unit represented by the formula (P-1) and the structural unit represented by the formula (P-2) is preferably 50 mass % or more. In the electrophotographic photosensitive member of the present disclosure, the ratio of the mass of the polyester resin to the mass of the binder resin is preferably 50 mass % or more.

In the polyester resin further including the structural unit represented by the formula (P-3) and the structural unit represented by the formula (P-4), the ratio of the amount of substance of the structural unit represented by the formula (P-1) and the structural unit represented by the formula (P-3) to the total amount of substance of the dicarboxylic acid-derived structural units constituting the polyester resin is preferably 0.50 or more.

In the polyester resin further including the structural unit represented by the formula (P-3) and the structural unit represented by the formula (P-4), the ratio of the total amount of substance of the structural unit represented by the formula (P-2) and the structural unit represented by the formula (P-4) to the total amount of substance of the bisphenol-derived structural units constituting the polyester resin is preferably 0.50 or more.

In the polyester resin, the amount of substance of the structural unit represented by the formula (P-1) is defined as M1 and the amount of substance of the structural unit represented by the formula (P-3) is defined as M3. The ratio of M1 to the total amount of substance of M1 and M3, M1/(M1+M3), is, from the viewpoint of bleeding of the conductive agent, preferably more than 0.30. M1/(M1+M3) is more preferably 0.50 or more.

In the polyester resin, the amount of substance of the structural unit represented by the formula (P-2) is defined as M2 and the amount of substance of the structural unit represented by the formula (P-4) is defined as M4. The ratio of M2 to the total amount of substance of M2 and M4, M2/(M2+M4), is, from the viewpoint of solubility, preferably 0.50 or less. That is, the ratio preferably satisfies 0<M2/(M2+M4)≤0.50.

The ratio of M3 to the total amount of substance of M1 and M3, M3/(M1+M3) preferably satisfies 0.30<M3/(M1+M3)≤0.70 from the viewpoint of bleeding of the conductive agent.

The ratio of M4 to the total amount of substance of M2 and M4, M4/(M2+M4), is, from the viewpoint of bleeding of the conductive agent, preferably 0.80 or less. The ratio is preferably 0.50 or more from the viewpoint of solubility. That is, the ratio preferably satisfies 0.5≤M4/(M2+M4)≤0.80.

The ¹H-nuclear magnetic resonance spectrum obtained by subjecting the polymer component recovered from the photosensitive layer to ¹H-nuclear magnetic resonance analysis in deuterated chloroform (proton NMR) can be used to determine the structure of the polyester resin of the present disclosure.

Hereinafter, specific procedures of recovering the polymer component from the surface layer of the photosensitive member and performing the NMR analysis will be described.

### Reprecipitation of Resin in Photosensitive Layer

The photosensitive member is cut at a position 10 cm, in the generatrix direction, from an end of the photosensitive member using a fretsaw.
The inner surface of the cut 10 cm cylindrical part is wiped with lens-cleaning paper impregnated with chloroform.
In order to dissolve the photosensitive layer, a 3 cm end portion of the cut cylindrical part is immersed in chloroform.
(About 60 mL of chloroform is placed into a 100 mL beaker and the end portion is immersed therein at room temperature for 5 minutes)
The chloroform solution in which the photosensitive layer has been dissolved is concentrated using a rotary evaporator to a volume of 2 mL to obtain the concentrated solution and the concentration is stopped.
A methanol/acetone mixed solution (volume ratio of 1:1, 50 mL) is prepared and the concentrated solution under stirring is entirely added dropwise, to cause reprecipitation.
Suction filtration is performed using a funnel (funnel: SU-40, filter paper: No. 5C-40, both are manufactured by Kiriyama Glass Works Co.).
The residue on the filter paper is collected using a spatula and vacuum-dried (at 70° C. for 1 hour).

### NMR Measurement

In order to prepare the measurement sample, 20 mg of the sample is dissolved in 1 g of deuterated chloroform containing tetramethylsilane as the internal standard and the entire solution is transferred into an NMR tube (deuterated chloroform: manufactured by Sigma-Aldrich Japan K.K., chloroform-d, product number: 612200).
(NMR tube: manufactured by Norell Inc., ST500-7, product number: S3010)
NMR measurement
   Apparatus: manufactured by Bruker Corporation, AVANCE500
   Conditions: proton NMR, automatic measurement using ICON-NMR
   Number of scans: 32 times
   Reference peak: The methyl group peak of tetramethylsilane is set to 0 ppm.

The electron transport agent can be at least one selected from the group consisting of the compound represented by the following formula (20), the compound represented by the following formula (21), the compound represented by the following formula (22), the compound represented by the following formula (23), the compound represented by the following formula (24), the compound represented by the following formula (25), and the compound represented by the following formula (26). When the photosensitive layer contains such an electron transport agent, the compatibility between the binder resin and a hole transport agent described later in the present disclosure is enhanced and the internal uniformity of the photosensitive layer is enhanced, which inferentially enhances advantages of the technique of the present disclosure.

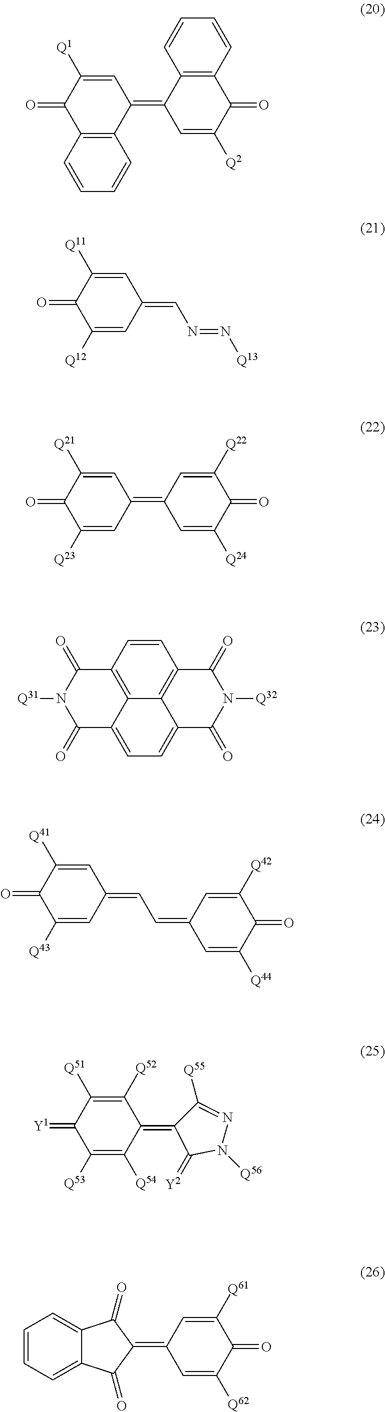

Q¹ and Q² in the formula (20), Q¹¹, Q¹², and Q¹³ in the formula (21), Q²¹, Q²², Q²³, and Q²⁴ in the formula (22), Q³¹ and Q³² in the formula (23), Q⁴¹, Q⁴², Q⁴³, and Q⁴⁴ in the formula (24), Q⁵¹, Q⁵², Q⁵³, Q⁵⁴, Q⁵⁵, and Q⁵⁶ in the formula (25), and Q⁶¹ and Q⁶² in the formula (26) each independently represent a hydrogen atom, a halogen atom, a cyano group, an alkyl group having 1 or more and 6 or less carbon atoms, an alkenyl group having 2 or more and 6 or less carbon atoms, an alkoxy group having 1 or more and 6 or less carbon atoms, or an aryl group that has 6 or more and 14 or less carbon atoms and may be substituted with at least one substituent selected from the group consisting of alkyl groups having 1 or more and 6 or less carbon atoms and halogen atoms. In the formula (25), Y¹ and Y² each independently represent an oxygen atom or a sulfur atom.

Q¹ and Q² in the formula (20), Q¹¹ to Q¹³ in the formula (21), Q²¹ to Q²⁴ in the formula (22), Q³¹ and Q³² in the formula (23), Q⁴¹ to Q⁴⁴ in the formula (24), Q⁵¹ to Q⁵⁶ in the formula (25), and Q⁶¹ and Q⁶² in the formula (26) each independently represent preferably a hydrogen atom, an alkyl group having 1 or more and 6 or less carbon atoms, or an aryl group that has 6 or more and 14 or less carbon atoms and may be substituted with at least one substituent selected from the group consisting of alkyl groups having 1 or more and 6 or less carbon atoms and halogen atoms. In the formula (25), Y¹ and Y² preferably represent an oxygen atom.

When Q¹ and Q² in the formula (20), Q¹¹ to Q¹³ in the formula (21), Q²¹ to Q²⁴ in the formula (22), Q³¹ and Q³² in the formula (23), Q⁴¹ to Q⁴⁴ in the formula (24), Q⁵¹ to Q⁵⁶ in the formula (25), and Q⁶¹ and Q⁶² in the formula (26) represent an alkyl group having 1 or more and 6 or less carbon atoms, they preferably represent an alkyl group having 1 or more and 5 or less carbon atoms, preferably represent a methyl group, an ethyl group, a propyl group, a butyl group, or a pentyl group, particularly preferably represent a methyl group, an isopropyl group, a tert-butyl group, or a 1,1-dimethylpropyl group.

When Q¹ and Q² in the formula (20), Q¹¹ to Q¹³ in the formula (21), Q²¹ to Q²⁴ in the formula (22), Q³¹ and Q³² in the formula (23), Q⁴¹ to Q⁴⁴ in the formula (24), Q⁵¹ to Q⁵⁶ in the formula (25), and Q⁶¹ and Q⁶² in the formula (26) represent an aryl group having 6 or more and 14 or less carbon atoms, they preferably represent an aryl group having 6 or more and 10 or less carbon atoms, more preferably represent a phenyl group. The aryl group having 6 or more and 14 or less carbon atoms may be substituted with at least one substituent selected from the group consisting of alkyl groups having 1 or more and 6 or less carbon atoms and halogen atoms. Such an alkyl group having 1 or more and 6 or less carbon atoms serving as a substituent is preferably an alkyl group having 1 or more and 3 or less carbon atoms, more preferably a methyl group or an ethyl group. Such a halogen atom serving as a substituent is preferably a fluorine atom, a chlorine atom, or a bromine atom, particularly preferably a chlorine atom. When the aryl group having 6 or more and 14 or less carbon atoms is substituted with a substituent, the number of such substituents is preferably 1 or more and 5 or less, more preferably 1 or 2. The aryl group having 6 or more and 14 or less carbon atoms and substituted with at least one substituent selected from the group consisting of alkyl groups having 1 or more and 6 or less carbon atoms and halogen atoms is preferably a chlorophenyl group, a dichlorophenyl group, or an ethylmethylphenyl group, more preferably a 4-chlorophenyl group, a 2,5-dichlorophenyl group, or a 2-ethyl-6-methylphenyl group.

Preferred examples of the compound represented by the formula (20) include the compounds represented by a formula (E-1) and a formula (E-4). Preferred examples of the compound represented by the formula (21) include the compound represented by a formula (E-5). Preferred examples of the compound represented by the formula (22) include the compound represented by a formula (E-7). Preferred examples of the compound represented by the formula (23) include the compound represented by a formula (E-6). Preferred examples of the compound represented by the formula (24) include the compound represented by a formula (E-8). Preferred examples of the compound represented by the formula (25) include the compound represented by a formula (E-2) and the compound represented by a formula (E-3). Preferred examples of the compound represented by the formula (26) include the compound represented by a formula (E-9). Hereafter, the compounds represented by the formulas (E-1) to (E-9) may be respectively referred to as electron transport agents (E-1) to (E-9).

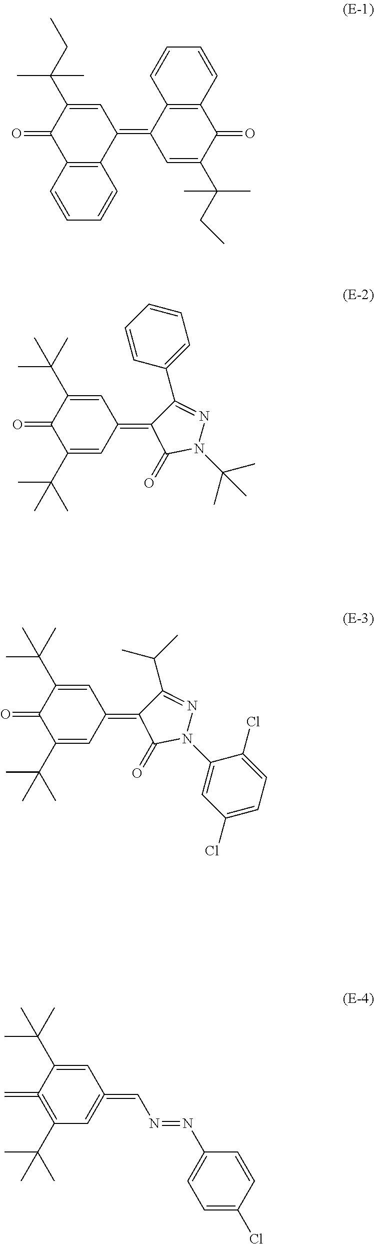

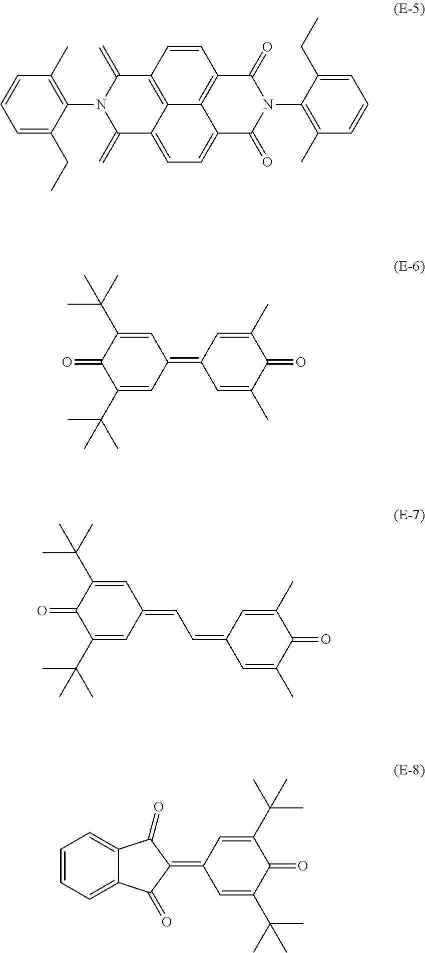 [SMILES: C=c1c2ccc3c(=O)n(-c4c(C)cccc4CC)c(=O)c4ccc(c(=C)n1-c1c(C)cccc1CC)c2c34 ; CC1=CC(=C2C=C(C(C)(C)C)C(=O)C(C(C)(C)C)=C2)C=C(C)C1=O ; CC1=CC(=CC=C2C=C(C(C)(C)C)C(=O)C(C(C)(C)C)=C2)C=C(C)C1=O ; CC(C)(C)C1=CC(=C2C(=O)c3ccccc3C2=O)C=C(C(C)(C)C)C1=O]

The photosensitive layer may contain a single electron transport agent alone or may contain two or more electron transport agents.

In the surface layer, the content of the electron transport agent relative to the polyester resin preferably satisfies the following conditions from the viewpoint of exhibition of the effect of the electron transport agent and bleeding of the ionic conductive agent. Specifically, in the surface layer, the content of the electron transport agent defined as E parts by mass and the content of the polyester resin defined as B parts by mass (with B=100) preferably satisfy 20≤E/(E+B)×100≤40, more preferably satisfy 11≤E/(E+B)≤30.

### Developing Roller

In the photosensitive member according to the present disclosure, the surface layer of the developing roller contains the ionic conductive agent represented by the following formula (1).

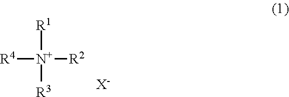

In the formula (1), R¹ to R⁴ represent a hydrocarbon group having 1 or more and 18 or less carbon atoms, and at least one of R¹ to R⁴ represents a hydrocarbon group having 4 or more and 18 or less carbon atoms. X⁻ represents an anion.

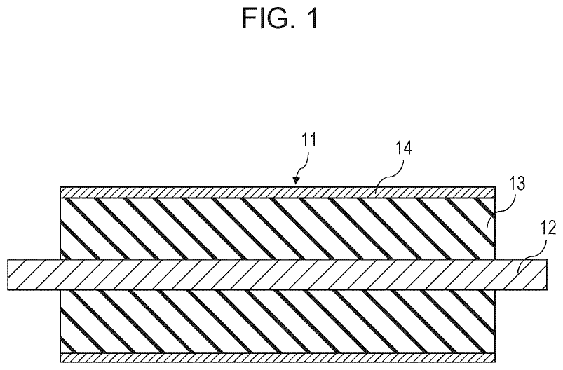

As illustrated in FIG. 1, the developing roller includes a shaft 12, an elastic layer 13 formed on the outer circumferential surface of the shaft 12, and a surface layer 14 formed on the outer circumferential surface of the elastic layer 13.

Hereinafter, the configuration of the developing roller according to an embodiment of the present disclosure will be described in detail.

### Shaft

The shaft 12 is preferably a shaft having conductivity and used for publicly known developing rollers. The shaft 12 is preferably formed of, for example, at least one metal selected from the group consisting of iron, aluminum, stainless steel, and brass. The shaft 12 formed of such a metal is also generally known as “core metal”.

The shaft 12 may contain an insulating resin. The insulating resin may be, for example, a thermoplastic resin or a thermosetting resin. The shaft 12 may include, for example, a core body formed of an insulating resin and a plating layer disposed on the core body. Such a shaft 12 can be obtained by, for example, plating a core body formed of an insulating resin to make it electrically conductive.

The shaft 12 is preferably a core metal in order to ensure high conductivity.

The shaft 12 preferably has the shape of, for example, a rod or a tube. The shaft 12 may have a sectional shape of, for example, a circle, an ellipse, or a noncircle such as a polygon. The outer circumferential surface of the shaft 12 may be subjected to a treatment such as a washing treatment, a degreasing treatment, or a primer treatment in order to improve adhesion to the elastic layer 13.

The shaft 12 is appropriately adjusted to a diameter and an axial length in accordance with the image-forming apparatus in which the shaft 12 is mounted. For example, when mounted in a compact and lightweight and/or high-speed image-forming apparatus, the shaft 12 is preferably adjusted to a small diameter, for example, a diameter of 4 mm to 10 mm.

The outer diameter of the shaft (the diameter of the circumcircle) is not particularly limited and may be appropriately adjusted in accordance with the form of the electrophotographic apparatus in which the shaft is disposed. For example, the outer diameter of the shaft 12 (the diameter of the circumcircle) is preferably 4 mm or more and 14 mm or less, more preferably 6 mm or more and 10 mm or less.

### Elastic Layer of Developing Roller

The elastic layer 13 is formed on the outer circumferential surface of the shaft 12 by heating and curing a rubber composition. The rubber composition for forming the elastic layer 13 preferably contains rubber, a conductivity-imparting agent, and, as desired, various additives.

### Rubber Composition

### Rubber

Examples of the rubber in the rubber composition include silicone rubber or silicone-modified rubber, nitrile rubber, ethylene-propylene rubber (including ethylene-propylene-diene rubber), styrene-butadiene rubber, butadiene rubber, isoprene rubber, natural rubber, acrylic rubber, chloroprene rubber, butyl rubber, epichlorohydrin rubber, urethane rubber, and fluororubber. The rubber in the rubber composition is preferably silicone rubber or silicone-modified rubber, or urethane rubber. The rubber in the rubber composition is particularly preferably silicone rubber or silicone-modified rubber because it can reduce compression set, exhibits excellent flexibility under low-temperature environments, and also provides excellent heat resistance, charging characteristics, and the like. Examples of the silicone rubber include crosslinked products of organopolysiloxanes such as dimethylpolysiloxane and diphenylpolysiloxane.

### Conductivity-Imparting Agent

Preferred examples of the conductivity-imparting agent include conductive agents having an electron conduction mechanism, such as carbon black, graphite, copper, aluminum, nickel, iron powder, and conductive metal oxides; conductive agents having an ion conduction mechanism, such as alkali metal salts and quaternary ammonium salts; and conductive agents containing conductive composite particles in which conductive particles such as carbon black particles are provided on the surfaces of silica particles.

The conductivity-imparting agent is particularly preferably carbon black. The carbon black is not particularly limited and preferred examples thereof include acetylene black, furnace black, channel black, Ketjenblack, and thermal black. Such carbon blacks may be used alone or in combination of two or more thereof. In order to provide a desired electric resistance, two or more of various conductive agents may be used in combination.

The content of the conductivity-imparting agent in the rubber composition relative to the total amount of the rubber composition is preferably 0.5 mass % or more and 20 mass % or less, more preferably 1.0 mass % or more and 15 mass % or less, still more preferably 2.0 mass % or more and 10 mass % or less. The content of the conductivity-imparting agent is adjusted to such a range, so that the resistance value of a developing roller 11 is further stabilized, the printing performance is further improved, the compression set of the elastic layer 13 is reduced, and the durability of the developing roller 11 is further improved.

### Various Additives

The rubber composition may further contain various additives in addition to the above-described components. Examples of the various additives include auxiliaries (such as chain extenders and crosslinking agents), catalysts, dispersants, foaming agents, anti-aging agents, antioxidants, fillers, pigments, colorants, processing aids, softeners, plasticizers, emulsifiers, heat resistance improvers, flame retardants, acid acceptors, thermal conductivity enhancers, release agents, and solvents.

A silicone rubber composition in which silicone rubber is employed as the rubber in the rubber composition may be, for example, an addition-curable millable conductive silicone rubber composition or an addition-curable liquid conductive silicone rubber composition.

The addition-curable millable conductive silicone rubber composition may contain, for example, (A) an organopolysiloxane represented by the following average composition formula (S1), (B) a filler, and (C) a conductivity-imparting agent.

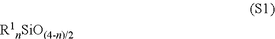

In the formula (S1), n represents a positive number of 1.95 or more and 2.05 or less. R¹ represents a substituted or unsubstituted monovalent hydrocarbon group. The number of carbon atoms of the hydrocarbon group is preferably 1 or more and 12 or less, more preferably 1 or more and 8 or less. In the organopolysiloxane (A), a plurality of R¹ may be the same, or a part of or all of them may be different from each other.

Examples of R¹ include alkyl groups such as a methyl group, an ethyl group, a propyl group, a butyl group, a hexyl group, and a dodecyl group; cycloalkyl groups such as a cyclohexyl group; alkenyl groups such as a vinyl group, an allyl group, a butenyl group, and a hexenyl group; aryl groups such as a phenyl group and a tolyl group; and aralkyl groups such as a β-phenylpropyl group. R¹ may be a group in which a part of or all of the hydrogen atoms of such a hydrocarbon group are substituted with substituents.

Examples of the substituents include halogen atoms and a cyano group. Examples of the hydrocarbon group having a substituent include a chloromethyl group, a trifluoropropyl group, and a cyanoethyl group.

The organopolysiloxane (A) preferably has its molecular chain ends capped with a trialkylsilyl group such as a trimethylsilyl group, a dialkylaralkylsilyl group such as a dimethylvinylsilyl group, a dialkylhydroxysilyl group such as a dimethylhydroxysilyl group, or a triaralkylsilyl group such as a trivinylsilyl group.

The organopolysiloxane (A) preferably intramolecularly has two or more alkenyl groups. The organopolysiloxane (A) preferably has an alkenyl group in an amount of 0.001 mol % or more and 5 mol % or less (more preferably 0.01 mol % or more and 0.5 mol % or less) based on the total amount of R¹. The alkenyl group of the organopolysiloxane (A) is particularly preferably a vinyl group.

The organopolysiloxane (A) can be obtained, for example, by co-hydrolytic condensation of one or two or more kinds of organohalosilanes, or by ring-opening polymerization of a cyclic polysiloxane such as a trimer or tetramer of siloxane. The organopolysiloxane (A) may be basically a linear diorganopolysiloxane and may be partially branched. The organopolysiloxane (A) may be a mixture of two or more organopolysiloxanes having different molecular structures.

The organopolysiloxane (A) preferably has a kinematic viscosity at 25° C. of 100 cSt or more, more preferably 100000 cSt or more and 10000000 cSt or less. The organopolysiloxane (A) preferably has a degree of polymerization of, for example, 100 or more, more preferably 3000 or more and 10000 or less.

The filler (B) may be, for example, a silica-based filler. Examples of the silica-based filler include fumed silica and precipitated silica.

The silica-based filler is preferably a surface-treated silica-based filler having been surface-treated using a silane coupling agent represented by R²Si(OR³)₃. In the formula, R² may be a vinyl group or a group having an amino group, such as a glycidyl group, a vinyl group, an aminopropyl group, a methacryloxy group, an N-phenylaminopropyl group, or a mercapto group. R³ may be an alkyl group such as a methyl group or an ethyl group.

The amount of the silica-based filler added relative to 100 parts by mass of the organopolysiloxane (A) is preferably 11 parts by mass or more and 39 parts by mass or less, more preferably 15 parts by mass or more and 35 parts by mass or less. The silica-based filler preferably has an average particle size of 1 μm or more and 80 μm or less, more preferably 2 μm or more and 40 μm or less. Note that the average particle size of the silica-based filler can be measured as a median diameter using a particle size distribution analyzer by the laser diffraction method.

The amount of the conductivity-imparting agent (C) added relative to 100 parts by mass of the organopolysiloxane (A) is preferably 0.5 parts by mass or more, more preferably 1 part by mass or more. The amount of the conductivity-imparting agent (C) added relative to 100 parts by mass of the organopolysiloxane (A) is preferably 15 parts by mass or less, more preferably 10 parts by mass or less.

The addition-curable millable conductive silicone rubber composition may further contain an additive other than (A) to (C). Examples of the additive include auxiliaries (such as chain extenders and crosslinking agents), catalysts, dispersants, foaming agents, anti-aging agents, antioxidants, pigments, colorants, processing aids, softeners, plasticizers, emulsifiers, heat resistance improvers, flame retardants, acid acceptors, thermal conductivity enhancers, release agents, and solvents.

Specific examples of the additive include dispersants such as dimethylsiloxane oils having a lower degree of polymerization than the organopolysiloxane (A), polyether-modified silicone oils, silanol, diphenylsilanediol, low-molecular-weight siloxanes capped with silanol groups at both ends such as α,ω-dimethylsiloxanediol, and silanes. Other specific examples of the additive include heat resistance improvers such as iron octylate, iron oxide, and cerium oxide. Other examples of the additive include various carbon-functional silanes and various olefin-based elastomers for improving adhesion, moldability, or the like.

The addition-curable liquid conductive silicone rubber composition may contain, for example, (D) an organopolysiloxane intramolecularly having two or more alkenyl groups, (E) an organohydrogenpolysiloxane intramolecularly having two or more hydrogen atoms bonding to silicon atoms, (F) a filler, (G) a conductivity-imparting agent, and (H) an addition reaction catalyst. The organopolysiloxane (D) is preferably a compound represented by the following average composition formula (S2).

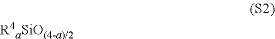

In the formula (S2), a represents a positive number of 1.5 or more and 2.8 or less, preferably 1.8 or more and 2.5 or less, more preferably 1.95 or more and 2.05 or less. In the organopolysiloxane (D), a plurality of R⁴ may represent substituted or unsubstituted monovalent hydrocarbon groups that may be identical or may be partially or entirely different. Note that at least two of R⁴ in the single molecule are alkenyl groups. The number of carbon atoms of the hydrocarbon group is preferably 1 or more and 12 or less, more preferably 1 or more and 8 or less.

Examples of R⁴ include the same groups as those exemplified for R¹ above. In the single molecule, at least two of R⁴ are preferably alkenyl groups and the other R⁴ are preferably alkyl groups. The alkenyl groups are preferably vinyl groups and the alkyl groups are preferably methyl groups. For example, 90% or more of R⁴ may be alkyl groups (preferably methyl groups).

In the organopolysiloxane (D), the alkenyl group content is, for example, preferably 1.0×10⁻⁶ mol/g or more and 5.0×10⁻³ mol/g or less, more preferably 5.0×10⁻⁶ mol/g or more and 1.0×10⁻³ mol/g or less.

The organopolysiloxane (D) is preferably liquid at 25° C. and preferably has a viscosity at 25° C. of 100 mPa·s or more and 1000000 mPa·s or less, more preferably 200 mPa·s or more and 100000 mPa·s or less. The organopolysiloxane (D) preferably has an average degree of polymerization of 100 or more and 800 or less, more preferably 150 or more and 600 or less.

The organohydrogenpolysiloxane (E) is preferably a compound represented by the following average composition formula (S3).

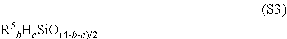

In the formula (S3), b represents a positive number of 0.7 or more and 2.1 or less, c represents a positive number of 0.001 or more and 1.0 or less, and b-c is 0.8 or more and 3.0 or less. In the organohydrogenpolysiloxane (E), a plurality of R⁵ represent substituted or unsubstituted monovalent hydrocarbon groups that may be identical or may be partially or entirely different. The hydrocarbon groups preferably have 1 or more and 10 or less carbon atoms. Note that examples of R⁵ include the same groups as those exemplified for R¹ above.

The organohydrogenpolysiloxane (E) includes, in a single molecule, two or more, preferably three or more, hydrogen atoms bonding to silicon atoms (Si—H). In a single molecule of the organohydrogenpolysiloxane (E), the number of hydrogen atoms bonding to silicon atoms is preferably 200 or less, still more preferably 100 or less.

In the organohydrogenpolysiloxane (E), the content of hydrogen atoms bonding to silicon atoms is preferably 0.001 mol/g or more and 0.017 mol/g or less, more preferably 0.002 mol/g or more and 0.015 mol/g or less.

Examples of the organohydrogenpolysiloxane (E) include both-end trimethylsiloxy group capped methylhydrogen polysiloxane, both-end trimethylsiloxy group capped dimethylsiloxane-methylhydrogensiloxane copolymers, both-end dimethylhydrogensiloxy group capped dimethylpolysiloxane, both-end dimethylhydrogensiloxy group capped dimethylsiloxane-methylhydrogensiloxane copolymers, both-end trimethylsiloxy group capped methylhydrogensiloxane-diphenylsiloxane copolymers, both-end trimethylsiloxy group capped methylhydrogensiloxane-diphenylsiloxane-dimethylsiloxane copolymers, copolymers composed of a (CH₃)₂HSiO_{1/2} unit and a SiO_{4/2} unit, and copolymers composed of a (CH₃)₂HSiO_{1/2} unit, a SiO_{4/2} unit, and a (C₆H₅)SiO_{3/2} unit.

The amount of the organohydrogenpolysiloxane (E) added relative to 100 parts by mass of the organopolysiloxane (D) is preferably 0.1 parts by mass or more and 30 parts by mass or less, more preferably 0.3 parts by mass or more and 20 parts by mass or less. The molar ratio of Si—H of the organohydrogenpolysiloxane (E) to the alkenyl groups of the organopolysiloxane (D) is preferably 0.3 to 5.0, more preferably 0.5 to 2.5.

The filler (F) may be, for example, an inorganic filler. The filler (F) is added to the addition-curable liquid conductive silicone rubber composition, to thereby reduce compression set, stabilize volume resistivity over time, and provide sufficiently high roller durability.

The filler (F) preferably has an average particle size of 1 μm or more and 30 μm or less, more preferably 2 μm or more and 20 μm or less. When the filler (F) has an average particle size of 1 μm or more, variation in volume resistivity over time is further suppressed. When the filler (F) has an average particle size of 30 μm or less, the resultant elastic layer 13 has higher durability. Note that the average particle size of the filler (F) can be measured as a median diameter using a particle size distribution analyzer by the laser diffraction method.

The filler (F) preferably has a bulk density of 0.1 g/cm³ or more and 0.5 g/cm³ or less, more preferably 0.15 g/cm³ or more and 0.45 g/cm³ or less. The bulk density of the filler (F) is adjusted to such a range, to thereby further reduce compression set, further suppress variation in volume resistivity over time, and provide the elastic layer 13 having higher durability. The bulk density of the filler (F) can be determined on the basis of the measurement method of apparent specific gravity in JISK6223.

Examples of the filler (F) include diatomaceous earth, perlite, mica, calcium carbonate, glass flakes, and hollow fillers. Of these, ground products of diatomaceous earth, perlite, and expanded perlite are preferably used as the filler (F).

The amount of the filler (F) added relative to 100 parts by mass of the organopolysiloxane (D) is preferably 5 parts by mass or more and 100 parts by mass or less, more preferably 10 parts by mass or more and 80 parts by mass or less.

The amount of the conductivity-imparting agent (G) added relative to 100 parts by mass of the organopolysiloxane (D) is preferably 0.5 parts by mass or more and 15 parts by mass or less, more preferably 1 part by mass or more and 10 parts by mass or less.

The addition reaction catalyst (H) is a catalyst that can activate the addition reaction between the organopolysiloxane (D) and the organohydrogenpolysiloxane (E). Examples of the addition reaction catalyst (H) include catalysts containing a platinum group element. Examples of the catalysts containing a platinum group element include platinum-based catalysts (such as platinum black, platinum(II) chloride, chloroplatinic acid, reaction products of chloroplatinic acid and monovalent alcohols, complexes of chloroplatinic acid and olefins, and platinum bis(acetoacetate)), palladium-based catalysts, and rhodium-based catalysts.

The amount of the addition reaction catalyst (H) added may be a catalytic amount. For example, the amount of the addition reaction catalyst (H) added is preferably set such that the amount of platinum group elements relative to the total mass of the organopolysiloxane (D) and the organohydrogenpolysiloxane (E) is 0.5 mass ppm or more and 1000 mass ppm or less. The amour of the addition reaction catalyst (H) added is more preferably set such that the amount of platinum group elements relative to the total mass of the organopolysiloxane (D) and the organohydrogenpolysiloxane (E) is 1 mass ppm or more and 500 mass ppm or less.

The addition-curable liquid conductive silicone rubber composition may further contain an additive other than (D) to (H). Examples of the additive include auxiliaries (such as chain extenders and crosslinking agents), foaming agents, dispersants, anti-aging agents, antioxidants, pigments, colorants, processing aids, softeners, plasticizers, emulsifiers, heat resistance improvers, flame retardants, acid acceptors, thermal conductivity enhancers, release agents, diluents, reactive diluents, and solvents.

Specific examples of the additive include dispersants such as low-molecular-weight siloxane esters, polyether-modified silicone oils, silanols, and phenylsilanediols. Other examples include heat resistance improvers such as iron octylate, iron oxide, and cerium oxide. Other examples include various carbon-functional silanes and various olefin-based elastomers for improving adhesion, moldability, or the like. Other examples include halogen compounds for imparting flame retardancy.

The addition-curable liquid conductive silicone rubber composition preferably has a viscosity at 25° C. of 5 Pa·s or more and 500 Pa·s or less, more preferably 5 Pa·s or more and 200 Pa·s or less.

The elastic layer 13 is formed by a publicly known molding method in which heat-curing and molding are performed simultaneously or sequentially, on the outer circumferential surface of the shaft 12. The method of curing the rubber composition is not particularly limited as long as the method can apply heat sufficient for curing of the rubber composition; and the method of molding the elastic layer 13 is also not particularly limited and examples include continuous vulcanization by extrusion, press molding, and mold molding by injection. For example, when the rubber composition is an addition-curable millable conductive silicone rubber composition, extrusion or the like can be selected; when the rubber composition is an addition-curable liquid conductive silicone rubber composition, a molding method using a mold can be selected.

During curing of the rubber composition, in the case of the addition-curable millable conductive silicone rubber composition, the heating temperature is preferably 100° C. or more and 500° C. or less, particularly preferably 120° C. or more and 300° C. or less, and the time is preferably several seconds or more and 1 hour or less, particularly preferably 10 seconds or more and 35 minutes or less. In the case of the addition-curable liquid conductive silicone rubber composition, the heating temperature is preferably 100° C. or more and 300° C. or less, particularly preferably 110° C. or more and 200° C. or less, and the time is preferably 5 minutes or more and 5 hours or less, particularly preferably 1 hour or more and 3 hours or less. As needed, secondary vulcanization may be performed. In the case of the addition-curable millable conductive silicone rubber composition, for example, curing conditions of a temperature of about 100° C. or more and about 200° C. or less and a time of about 1 hour or more and about 20 hours or less are selected. In the case of the addition-curable liquid conductive silicone rubber composition, for example, curing conditions of a temperature of about 120° C. or more and about 250° C. or less and a time of about 2 hours or more and about 70 hours or less are selected.

The rubber composition can be foamed and cured by a known method to easily form a sponge-like elastic layer 13 having pores. The thickness of the elastic layer 13 is not particularly limited and is preferably 0.1 mm or more and 6 mm or less, more preferably 1 mm or more and 4 mm or less. In this Specification, the term “thickness” refers to the thickness in a direction perpendicular to the axial direction of the developing roller 11. The outer diameter of the elastic layer 13 is not particularly limited and is preferably, for example, 6 mm or more and 25 mm or less. The outer circumferential surface of the elastic layer 13 may be subjected to a surface treatment such as primer treatment, corona treatment, plasma treatment, excimer treatment, UV treatment, ITRO treatment, or flame treatment for the purpose of, for example, improving the adhesion to the surface layer 14. The method for forming the elastic layer 13 is not particularly limited. For example, the elastic layer 13 may be formed by, for example, extrusion or LIMS molding of a silicone rubber composition. Alternatively, the elastic layer 13 may be formed by, for example, grinding or polishing of an elastic body formed on the shaft 12 (cured product of the silicone rubber composition).

### Surface Layer of Developing Roller

The surface layer 14 is disposed on the outer circumference of the elastic layer 13 and on the outermost surface of the developing roller. The surface layer 14 is formed by applying a resin composition to the outer circumferential surface of the elastic layer 13 or an optionally formed primer layer, and subsequently heating and curing the applied resin composition. The resin composition contains at least a urethane-forming component for forming a urethane resin as the second binder resin and silica particles.

The surface layer 14 is not necessarily formed by heating and curing of a resin composition, and may be formed by silicone coating treatment using ethyl silicate or silicone coating treatment using this treatment agent further containing a titanium-based, aluminum-based, or zirconium-based material or the like. The resin composition is applied by, for example, a publicly known coating process such as a coating process of applying a coating solution of the resin composition, a dipping process of dipping the elastic layer 13 or the like in the coating solution, or a spray coating process of spraying the coating solution to the elastic layer 13 or the like. The resin composition alone may be applied or a coating solution provided by adding, to the resin composition, for example, water or a volatile solvent such as an alcohol such as methanol or ethanol, an aromatic solvent such as xylene or toluene, or an ester-based solvent such as ethyl acetate or butyl acetate may be applied.

The process of curing the applied resin composition is not particularly limited as long as it applies heat or moisture required for, for example, curing of the resin composition. For example, the process of curing the resin composition may be a process of heating, with a heater, the elastic layer 13 or the like coated with the resin composition, or a process of leaving at rest, at high humidity, the elastic layer 13 or the like coated with the resin composition. The heating temperature at which the resin composition is heated and cured is preferably, for example, 100° C. or more and 200° C. or less, particularly preferably 120° C. or more and 160° C. or less. The heating time is preferably 10 minutes or more and 120 minutes or less, more preferably 30 minutes or more and 60 minutes or less. Note that, instead of the coating, for example, the following process can be employed: a resin composition is used to form a layer on the outer circumferential surface of the elastic layer 13 or the primer layer by a publicly known molding process such as extrusion, press molding, or injection molding; during the layer formation or after the layer formation, the resin composition of the layer is cured.

In the surface layer 14 formed in this way, the precursor forming the resin may react with a conductivity-imparting agent and the like described later to form an integration or a composite; alternatively, the conductivity-imparting agent may be dispersed in the resin without reacting with the precursor forming the resin.

The developing roller according to the present disclosure contains, in the surface layer, the compound represented by the formula (1), an ionic conductive agent. In the formula (1), R¹ to R⁴ represent a hydrocarbon group having 1 or more and 18 or less carbon atoms and at least one of R¹ to R⁴ represents a hydrocarbon group having 4 or more and 18 or less carbon atoms. At least two of R¹ to R⁴ are preferably a hydrocarbon group having 4 or more and 18 or less carbon atoms.

X⁻ represents an anion that is any anion. Examples of the anion include bis(trifluoromethanesulfonyl)imide, halogen ions, OH⁻, ClO₄⁻, BF₄⁻, SO₄²⁻, HSO₄⁻, COOH⁻, and organic sulfate ions. Of these, preferred are anions other than anions of acids.

Examples include tributylmethylammonium iodide, tributylmethylammonium bis(trifluoromethanesulfonyl)imide, tetramethylammonium bromide, tetramethylammonium iodide, tetramethylammonium chloride, tetraethylammonium chloride, tetraethylammonium bromide, tetrabutylammonium fluoride, tetrabutylammonium bromide, tetrabutylammonium iodide, trimethylpropylammonium bisbromide, trimethylpropylammonium bis(trifluoromethanesulfonyl)imide, butyltrimethylammonium bromide, butyltrimethylammonium bis(trifluoromethanesulfonyl)imide, trimethylhexylammonium bis(trifluoromethanesulfonyl)imide, n-octyltrimethylammonium chloride, n-octyltrimethylammonium bromide, n-octyltrimethylammonium bromide, methyltrioctylammonium hexafluorophosphate, tetraamylammonium chloride, tetraamylammonium iodide, tetraamylammonium bromide, tetrapropylammonium bromide, tetrapropylammonium iodide, tetrapropylammonium hydroxide, tetrahexylammonium bromide, tetrahexylammonium iodide, tetrahexylammonium hydroxide, hexadecyltrimethylammonium chloride, hexadecyltrimethylammonium bromide, hexadecyltrimethylammonium hydroxide, trimethylphenylammonium chloride, trimethylphenylammonium chloride, trimethylphenylammonium iodide, trimethylphenylammonium hydroxide, benzyltrimethylammonium chloride, benzyltrimethylammonium hydroxide, benzyltriethylammonium chloride, benzyltriethylammonium iodide, benzyltriethylammonium hydroxide, triethylmethylammonium chloride, decyltrimethylammonium bromide, decyltrimethylammonium chloride, dodecyltrimethylammonium bromide, dodecyltrimethylammonium chloride, trimethyltetradecylammonium bromide, trimethyltetradecylammonium chloride, trimethylstearylammonium chloride, diallyldimethylammonium chloride, didodecyldimethylammonium chloride, benzyltributylammonium chloride, benzyldodecyldimethylammonium chloride, tetradecyldimethylbenzylammonium chloride, benzylmyristyldimethylammonium chloride, benzylcetyldimethylammonium chloride, benzyldimethylstearylammonium chloride, benzyldimethylphenylammonium chloride, tetraheptylammonium bromide, tetra-n-octylammonium bromide, tetra(decyl)ammonium bromide, trimethylnonylammonium bromide, heptadecyltrimethylammonium bromide, hexyldimethyloctylammonium bromide, dimethyldioctylammonium bromide, dimethyldimyristylammonium bromide, ethylhexadecyldimethylammonium bromide, dimethyldipalmitylammonium bromide, dimethyldioctadecylammonium bromide, ethyltrimethylammonium iodide, and tetraethylammonium iodide. Among these, those having a cation with a tributylmethylammonium structure are particularly preferred from the viewpoint of compatibility with the base material of the developing roller.

The surface layer contains at least one quaternary ammonium salt and may contain two or more quaternary ammonium salts.

In order to suppress attack to the electron transport agent by the compound represented by the formula (1), a formula (2) below is preferably satisfied.

In the following formula (2), SP_{E} (J/cm³)^{0.5} is defined as the SP value of a compound having the smallest SP value among the electron transport agents. SP₁ (J/cm³)^{0.5} is defined as the SP value of a cation having the largest SP value among the cations of the compounds represented by the formula (1). SP_{E} and SP_{I} preferably satisfy the formula (2).

$${SP}_{E} - {SP}_{I} \geq 5.2 \qquad ( 2 )$$

When the electron transport agents are used alone, the SP value of the electron transport agent used alone is defined as SP_{E} (J/cm³)^{0.5}. When the compounds represented by the formula (1) are used alone, the SP value of the cation of the compound represented by the formula (1) and used alone is defined as SP_{I} (J/cm³)^{0.5}.

Examples of the cation of the compound represented by the formula (1) are as follows.

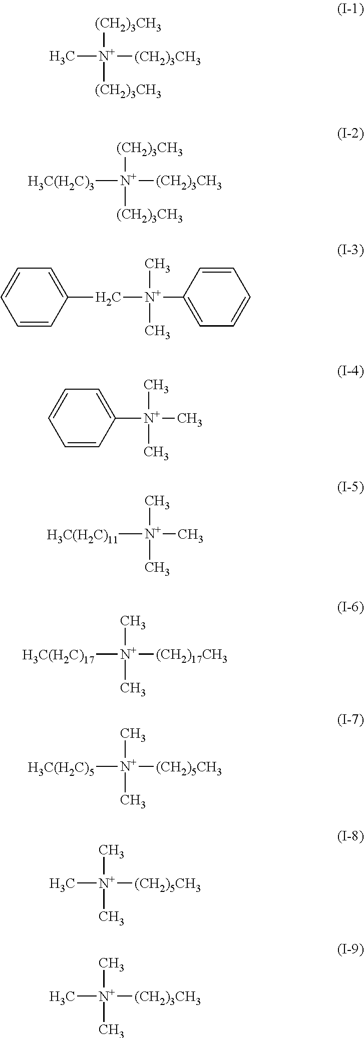

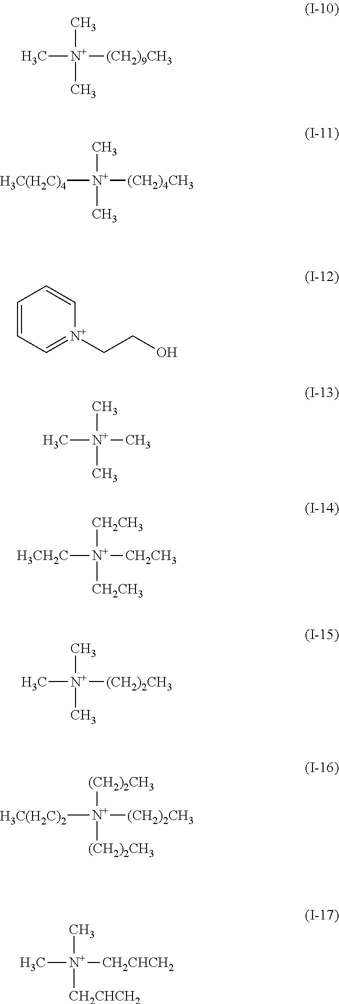

Of the cations of the compounds represented by the formula (1), preferred is the cation represented by the formula (I-1).

### Method for Calculating Solubility Parameter (SP Value)

SP values of resins are determined in accordance with the calculation method proposed by Fedors in the following manner.

First, SP values of monomer units constituting such a resin are determined in the following manner. Such a monomer unit constituting the resin means a molecular structure in which the double bond of the monomer used for obtaining the resin by polymerization is cleaved by polymerization.

For example, when the SP value (σm) (J/cm³)^{0.5} of a monomer unit is calculated, for the atoms or atomic groups in the molecular structure of the monomer unit, the evaporation energy (Δei) (J/mol) and molar volume (Δvi) (cm³/mol) are determined from the table described in “Polym. Eng. Sci., 14(2), 147-154(1974)” and the SP value is calculated by the following formula (11).

$$σ m = {( \sum Δ ei / \sum Δ vi )}^{0.5} \qquad ( 11 )$$

The calculation method is used to thereby determine that, for example, the electron transport agent of the formula (E-1) below has an SP value SP_{E} of 21.1484 (J/cm³)^{0.5} and the anion in the ionic conductive agent of the formula (I-1) below has an SP value SP_{I} of 15.808 (J/cm³)^{0.5}.

### Electrophotographic Apparatus

The electrophotographic apparatus of the present disclosure includes the above-described electrophotographic photosensitive member, a charging unit, an exposure unit, a developing unit, and a transfer unit. The charging unit charges the surface of the electrophotographic photosensitive member. The exposure unit irradiates the charged surface of the photosensitive member with light to form an electrostatic latent image on the surface of the photosensitive member. The developing unit includes toner, and uses the toner to develop the electrostatic latent image formed on the surface of the photosensitive member to form a toner image on the surface of the photosensitive member. The developing unit is the above-described developing roller.

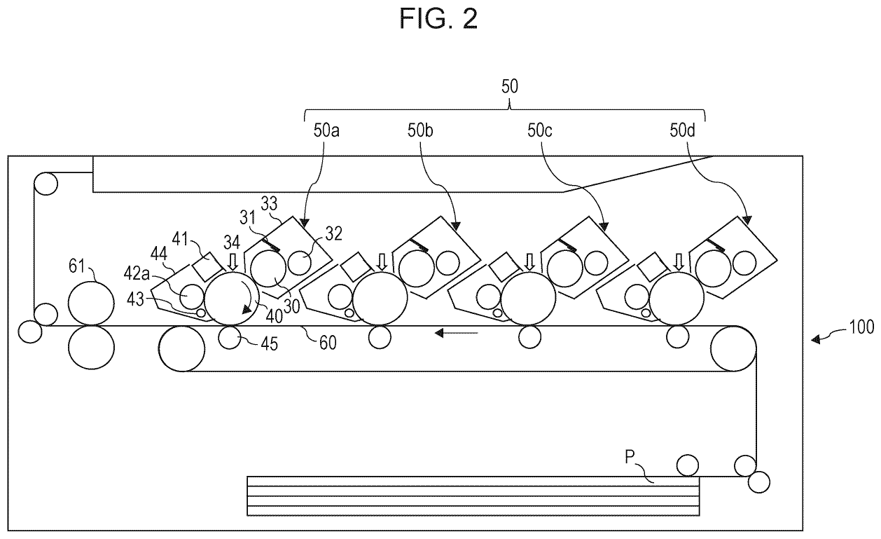

Referring to FIG. 2, the tandem-type color electrophotographic apparatus will be described as an example.

Referring to FIG. 2, an electrophotographic apparatus 100 includes image-forming units 50a, 50b, 50c, and 50d, a transfer belt 60, and a fixing device 61. Hereafter, the image-forming units 50a, 50b, 50c, and 50d will be collectively referred to as an image-forming unit 50 when there is no need to distinguish among them. The image-forming unit 50 includes an image-carrying member 40, a charging device 41 serving as the charging unit, an exposure device 34 serving as the exposure unit, a developing device 33 serving as the developing unit, and a transfer device 45 serving as the transfer unit. The developing device 33 includes a developing roller 30, a layer-forming blade 31, and a toner supply roller 32. The image-carrying member 40 is a photosensitive member. The electrophotographic apparatus 100 includes an image-carrying member unit 44. The electrophotographic apparatus 100 includes a cleaning roller 42a and a pre-exposure device 43. A recording medium P is disposed in a lower portion of the electrophotographic apparatus. At the central position of the image-forming unit 50, the image-carrying member 40 is disposed. The image-carrying member 40 is disposed so as to be rotatable in the arrow direction (clockwise direction in FIG. 2). Around the image-carrying member 40, the charging device 41, the exposure device 34, the developing device 33, and the transfer device 45 are disposed in this order from the upstream position in the rotational direction of the image-carrying member 40.

The image-forming units 50a to 50d successively superimpose toner images of a plurality of colors (for example, four colors of black, cyan, magenta, and yellow) on the recording medium P on the transfer belt 60. The charging device 41 charges the surface (for example, the circumferential surface) of the image-carrying member 40 to a positive polarity. When the image-carrying member 40 is a single-layer photosensitive member, the surface of the image-carrying member 40 is charged to a positive polarity. The charging device 41 is, for example, a charging roller. The exposure device 34 irradiates the charged surface of the image-carrying member 40 with exposure light. In other words, the exposure device 34 exposes the charged surface of the image-carrying member 40. This results in formation of an electrostatic latent image on the surface of the image-carrying member 40. The electrostatic latent image is formed on the basis of the image data input into the electrophotographic apparatus 100. The developing device 33 includes toner, supplies the toner to the surface of the image-carrying member 40, and develops the electrostatic latent image to form a toner image. The developing device 33 (for example, the surface of the developing device 33, more specifically, the circumferential surface of the developing device 33) is in contact with the surface of the image-carrying member 40. Thus, the electrophotographic apparatus 100 employs the contact developing system. The developing device 30 is, for example, a developing roller. When the developer is a single-component developer, the developing device 30 supplies the toner that is the single-component developer to the electrostatic latent image formed on the image-carrying member 40. When the developer is a two-component developer, the developing device 33 supplies the toner out of the toner and the carrier contained in the two-component developer, to the electrostatic latent image formed on the image-carrying member 40. Thus, the image-carrying member 40 carries the toner image. The transfer belt 60 conveys the recording medium P to the region between the image-carrying member 40 and the transfer device 45. The transfer belt 60 is an endless belt. The transfer belt 60 is disposed so as to be rotatable in the arrow direction (counterclockwise direction in FIG. 2). The transfer device 45 transfers the toner image developed by the developing device 33, from the surface of the image-carrying member 40 to a receiving member. The receiving member is the recording medium P. When the toner image is transferred, the image-carrying member 40 is in contact with the recording medium P. Thus, the electrophotographic apparatus 100 employs the direct transfer method. The transfer device 45 is, for example, a transfer roller. The recording medium P onto which the toner image has been transferred by the transfer device 45 is conveyed by the transfer belt 60 to the fixing device 61. The fixing device 61 is, for example, a heating roller and/or a press roller. The unfixed toner image transferred by the transfer device 45 is heated and/or pressed by the fixing device 61. The toner image is heated and/or pressed, so that the toner image is fixed on the recording medium P. As a result, the image is formed on the recording medium P. An example of the electrophotographic apparatus has been described so far; however, the electrophotographic apparatus is not limited to the above-described electrophotographic apparatus 100. The above-described electrophotographic apparatus 100 is a color electrophotographic apparatus; alternatively, the electrophotographic apparatus may be a monochrome electrophotographic apparatus. In this case, the electrophotographic apparatus includes, for example, a single image-forming unit alone.

The above-described electrophotographic apparatus 100 employs the tandem system; alternatively, an electrophotographic apparatus may employ the rotary system. The charging device 41 has been described with reference to the charging roller serving as an example; alternatively, the charging device may be a charging device other than charging rollers (such as a scorotron charger, a charging brush, or a corotron charger). The above-described electrophotographic apparatus 100 employs the contact developing system; alternatively, the electrophotographic apparatus may employ the non-contact developing system. The above-described electrophotographic apparatus 100 employs the direct transfer system; alternatively, the electrophotographic apparatus may employ the intermediate transfer system. When the electrophotographic apparatus employs the intermediate transfer system, the receiving member corresponds to an intermediate transfer belt.

In the electrophotographic apparatus, the above-described image-forming unit 50 does not include a cleaning member; alternatively, the image-forming unit 50 may further include a cleaning member (such as a cleaning blade). Note that the above-described image-forming unit 50 does not include a discharging device; alternatively, the image-forming unit may further include a discharging device.

### Process Cartridge

The process cartridge according to the present disclosure is:
a process cartridge including:
   an electrophotographic photosensitive member; and a contact developing device including toner and a developing roller and configured to bring the developing roller carrying the toner into contact with the electrophotographic photosensitive member to develop an electrostatic latent image formed on a surface of the electrophotographic photosensitive member,
the process cartridge collectively supporting the electrophotographic photosensitive member and the contact developing device, and being attachable to and detachable from a body of an electrophotographic apparatus,
wherein the electrophotographic photosensitive member includes a surface layer containing a binder resin and an electron transport agent,
the surface layer contains a polyester resin as the binder resin,
the polyester resin includes a structural unit represented by a formula (P-1) below and a structural unit represented by a formula (P-2) below, and
the developing roller includes a surface layer containing a compound represented by a formula (1) below:

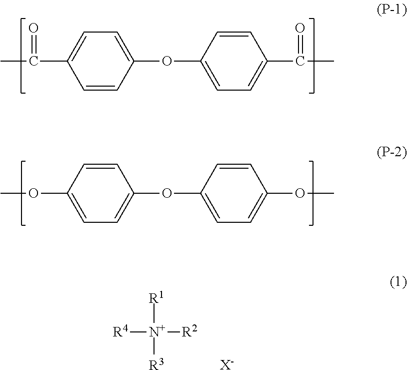

in the formula (1), R¹ to R⁴ represent a hydrocarbon group having 1 or more and 18 or less carbon atoms and at least one of R¹ to R⁴ represents a hydrocarbon group having 4 or more and 18 or less carbon atoms, and X⁻ represents an anion.

Referring continuously to FIG. 2, an example of the process cartridge according to the present disclosure will be described. The process cartridge corresponds to each of the image-forming units 50a to 50d. The process cartridge includes an image-carrying member 40. The image-carrying member 40 is a photosensitive member. The process cartridge includes the image-carrying member 40 and a developing device 33. The process cartridge can include, in addition to the image-carrying member 40 and the developing device 33, a charging device 41. The process cartridge may further include a cleaning member (not shown) and a discharging device (not shown). The process cartridge is designed so as to be attachable to and detachable from the electrophotographic apparatus 100. Thus, the process cartridge is easy to handle and, when the sensitivity characteristics or the like of the image-carrying member 40 deteriorate, the process cartridge including the image-carrying member 40 can be easily and rapidly replaced.

### EXAMPLES

Hereinafter, the technique of the present disclosure will be described further in detail with reference to Examples and Comparative Examples. The technique of the present disclosure is not limited in any way by the following Examples as long as it does not depart from the spirit and scope thereof. Note that, in the following description of Examples, “parts” are based on mass unless otherwise specified.

### Production of Polyester Resins (PAR)

### Synthesis of Resin (PAR-1)

The reaction vessel employed was a three-neck flask equipped with a thermometer, a three-way stopcock, and a dropping funnel. Into the reaction vessel, the following materials were placed.
Compound (BP-2) serving as monomer (8.2 millimoles)
Compound (BP-5) serving as monomer (32.8 millimoles)
2,6-Dimethylphenol (DMP) serving as end capping agent (0.413 millimoles)
Sodium hydroxide (98 millimoles)
Benzyltributylammonium chloride (0.384 millimoles)

The air within the reaction vessel was purged with argon gas. To the content of the reaction vessel, water (300 mL) was added. The content of the reaction vessel was stirred at 50° C. for 1 hour. The content of the reaction vessel was cooled to 10° C., to obtain an alkaline aqueous solution A2.

Subsequently, a dicarboxylic acid dichloride (20.8 millimoles) being a derivative of the compound (DC-1) and serving as a monomer and a dicarboxylic acid dichloride (11.2 millimoles) being a derivative of the compound (DC-4) and serving as a monomer were dissolved in chloroform (150 mL). This provided a chloroform solution B2.

To the alkaline aqueous solution A2, the chloroform solution B2 was slowly added dropwise using a dropping funnel over 110 minutes. While the temperature (liquid temperature) of the content of the reaction vessel was adjusted to 15±5° C., the content of the reaction vessel was stirred for 4 hours to cause the polymerization reaction to proceed. The upper layer (aqueous layer) of the content of the reaction vessel was removed by decantation to obtain an organic layer. Subsequently, to an Erlenmeyer flask, ion-exchanged water (400 mL) was added. Into the Erlenmeyer flask, the obtained organic layer was further added. Into the Erlenmeyer flask, chloroform (400 mL) and acetic acid (2 mL) were further added. The content of the Erlenmeyer flask was stirred at room temperature (25° C.) for 30 minutes. The upper layer (aqueous layer) of the content of the Erlenmeyer flask was removed by decantation, to obtain an organic layer. A separatory funnel was used to rinse the obtained organic layer using ion-exchanged water (1 L). The rising using the ion-exchanged water was repeated 5 times, to obtain the rinsed organic layer. Subsequently, the rinsed organic layer was filtered to obtain filtrate. The obtained filtrate was slowly added dropwise to methanol (1 L), to obtain precipitate. The precipitate was collected by filtration. The collected precipitate was vacuum-dried at a temperature of 70° C. for 12 hours. As a result, a resin (PAR-1) having a viscosity-average molecular weight of 52000 was obtained.

### Synthesis of Resin (PAR-11)

The reaction vessel employed was a three-neck flask equipped with a thermometer, a three-way stopcock, and a dropping funnel. Into the reaction vessel, the following materials were placed.
Compound (BP-2) serving as monomer (41.0 millimoles)
2,6-Dimethylphenol (DMP) serving as end capping agent (0.625 millimoles)
Sodium hydroxide (98 millimoles)
Benzyltributylammonium chloride (0.384 millimoles)

The air within the reaction vessel was purged with argon gas. To the content of the reaction vessel, water (300 mL) was added. The content of the reaction vessel was stirred at 50° C. for 1 hour. The content of the reaction vessel was cooled to 10° C., to obtain an alkaline aqueous solution A1.

Subsequently, a dicarboxylic acid dichloride (32.0 millimoles) being a derivative of the compound (DC-1) and serving as a monomer was dissolved in chloroform (150 mL). This provided a chloroform solution B1.

To the alkaline aqueous solution A1, the chloroform solution B1 was slowly added dropwise using a dropping funnel over 110 minutes. While the temperature (liquid temperature) of the content of the reaction vessel was adjusted to 15±5° C., the content of the reaction vessel was stirred for 4 hours to cause the polymerization reaction to proceed. The upper layer (aqueous layer) of the content of the reaction vessel was removed by decantation to obtain an organic layer. Subsequently, to an Erlenmeyer flask, ion-exchanged water (400 mL) was added. Into the Erlenmeyer flask, the obtained organic layer was further added. Into the Erlenmeyer flask, chloroform (400 mL) and acetic acid (2 mL) were further added. The content of the Erlenmeyer flask was stirred at room temperature (25° C.) for 30 minutes. The upper layer (aqueous layer) of the content of the Erlenmeyer flask was removed by decantation, to obtain an organic layer. A separatory funnel was used to rinse the obtained organic layer using ion-exchanged water (1 L). The rising using the ion-exchanged water was repeated 5 times, to obtain the rinsed organic layer. Subsequently, the rinsed organic layer was filtered to obtain filtrate. The obtained filtrate was slowly added dropwise to methanol (1 L), to obtain precipitate. The precipitate was collected by filtration. The collected precipitate was vacuum-dried at a temperature of 70° C. for 12 hours. As a result, a resin (PAR-li) having a viscosity-average molecular weight of 35000 was obtained.

### Synthesis of Resins (PAR-2) to (PAR-10) and (PAR-12) to (PAR-19)

Synthesis was performed by the same method as in the synthesis of the resin (PAR-1) having a viscosity-average molecular weight of 52000 except that the ratios of the bisphenols and the dicarboxylic acids and the end capping agent were changed, to obtain resins (PAR) having a viscosity-average molecular weight in Table 1. Note that the smaller the amount of end capping agent added, the higher the viscosity-average molecular weight of the resin (PAR).

TABLE 1

| | Dicarboxylic acid | | Bisphenol | | End capping | Molecular |
|---|---|---|---|---|---|---|
| Resin | DC-1 | DC-4 | BP-2 | BP-5 | agent | weight |
| PAR-1 | 65 | 35 | 20 | 80 | DMP | 52000 |
| PAR-2 | 50 | 50 | 25 | 75 | DMP | 53000 |
| PAR-3 | 35 | 65 | 20 | 80 | DMP | 52700 |
| PAR-4 | 65 | 35 | 40 | 60 | DMP | 58000 |
| PAR-5 | 66 | 34 | 20 | 80 | PFH | 54300 |
| PAR-6 | 75 | 25 | 20 | 80 | DMP | 60000 |
| PAR-7 | 25 | 75 | 20 | 80 | DMP | 51000 |
| PAR-8 | 65 | 35 | 15 | 85 | DMP | 51000 |
| PAR-9 | 65 | 35 | 55 | 45 | DMP | 57000 |
| PAR-10 | 100 | 0 | 100 | 0 | DMP | 13000 |
| PAR-11 | 100 | 0 | 100 | 0 | DMP | 35000 |
| PAR-12 | 100 | 0 | 100 | 0 | DMP | 55000 |
| PAR-13 | 100 | 0 | 100 | 0 | DMP | 66000 |
| PAR-14 | 100 | 0 | 100 | 0 | DMP | 78000 |
| PAR-15 | 65 | 35 | 100 | 0 | DMP | 52000 |
| PAR-16 | 100 | 0 | 20 | 80 | DMP | 58000 |
| PAR-17 | 0 | 100 | 0 | 100 | DMP | 68000 |
| PAR-18 | 65 | 35 | 0 | 100 | DMP | 60000 |
| PAR-19 | 0 | 100 | 20 | 80 | DMP | 65000 |

In Table 1, the values in Bisphenol refer to, in the resins (PAR-1) to (PAR-19), the ratio of the amount of substance of a bisphenol to the total amount of substance of the two bisphenols. The values in Dicarboxylic acid refer to the ratio of the amount of substance of a dicarboxylic acid to the total amount of substance of the two dicarboxylic acids. PFH refers to 1H,1H-perfluoro-1-heptanol. The values in Molecular weight refer to viscosity-average molecular weight.

### Production of Electrophotographic Photosensitive Members

### Production of Photosensitive Member 1

The following materials were prepared.
Charge generation agent represented by formula (CGM-1) below: 2.0 parts by mass
Hole transport agent represented by formula (H-11) below: 70.0 parts by mass
Electron transport agent represented by formula (E-1) below: 40.0 parts by mass
Additive represented by formula (T-1) below: 14.0 parts by mass
Polyester resin including structural units represented by formulas (P-1), (P-2), (P-3), and (P-4) below and referred to as PAR-1 in Table 1: 100.0 parts by mass
Tetrahydrofuran: 500.0 parts by mass

The above-described materials were mixed for 20 minutes using a rod-type sound-wave transducer to obtain a dispersion liquid. The dispersion liquid was filtered using a filter having a pore size of 5 μm to obtain a photosensitive layer-forming coating solution. The photosensitive layer-forming coating solution was applied to a conductive support (an aluminum drum-shaped support) by the dip coating method and dried in hot air at 120° C. for 50 minutes. In this way, a photosensitive layer (layer thickness: 30 μm) was formed on the conductive support, to obtain a photosensitive member 1.

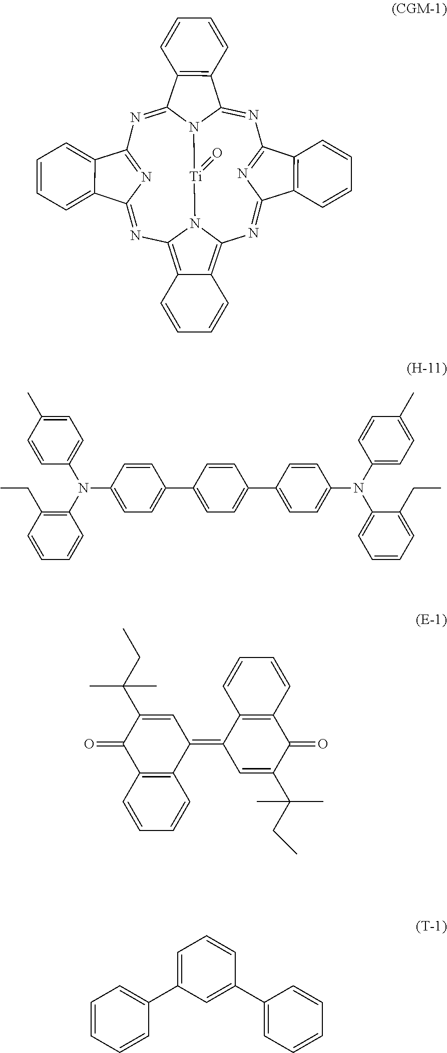

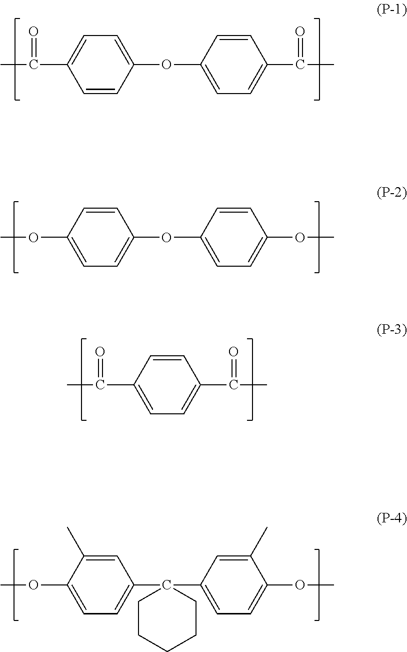

### Production of Photosensitive Members 2 to 28

The photosensitive members 2 to 28 were produced as with the photosensitive member 1 except that the types of materials and mixing ratios were appropriately changed, to obtain photosensitive members having configurations described in Table 2. In Table 2, for E-2, an electron transport agent represented by the following formula (E-2) was used.

TABLE 2

| | | | Content B of | Content E of | |
|---|---|---|---|---|---|
| | | Electron | binder resin | transport agent | E/(E + |
| | | transport | (parts by | electron (parts | B) × |
| | Resin | agent | mass) | by mass) | 100 |
| Photosensitive | PAR-1 | E-1 | 100 | 40 | 28.6 |
| member 1 | | | | | |
| Photosensitive | PAR-2 | E-1 | 100 | 40 | 28.6 |
| member 2 | | | | | |
| Photosensitive | PAR-3 | E-1 | 100 | 40 | 28.6 |
| member 3 | | | | | |
| Photosensitive | PAR-4 | E-1 | 100 | 40 | 28.6 |
| member 4 | | | | | |
| Photosensitive | PAR-5 | E-1 | 100 | 40 | 28.6 |
| member 5 | | | | | |
| Photosensitive | PAR-6 | E-1 | 100 | 40 | 28.6 |
| member 6 | | | | | |
| Photosensitive | PAR-7 | E-1 | 100 | 40 | 28.6 |
| member 7 | | | | | |
| Photosensitive | PAR-8 | E-1 | 100 | 40 | 28.6 |
| member 8 | | | | | |
| Photosensitive | PAR-9 | E-1 | 100 | 40 | 28.6 |
| member 9 | | | | | |
| Photosensitive | PAR-10 | E-1 | 100 | 40 | 28.6 |
| member 10 | | | | | |
| Photosensitive | PAR-11 | E-1 | 100 | 40 | 28.6 |
| member 11 | | | | | |
| Photosensitive | PAR-12 | E-1 | 100 | 40 | 28.6 |
| member 12 | | | | | |
| Photosensitive | PAR-13 | E-1 | 100 | 40 | 28.6 |
| member 13 | | | | | |
| Photosensitive | PAR-14 | E-1 | 100 | 40 | 28.6 |
| member 14 | | | | | |
| Photosensitive | PAR-15 | E-1 | 100 | 40 | 28.6 |
| member 15 | | | | | |
| Photosensitive | PAR-16 | E-1 | 100 | 40 | 28.6 |
| member 16 | | | | | |
| Photosensitive | PAR-1 | E-2 | 100 | 40 | 28.6 |
| member 17 | | | | | |
| Photosensitive | PAR-1 | E-1 | 100 | 25 | 20.0 |
| member 18 | | | | | |
| Photosensitive | PAR-1 | E-1 | 100 | 65 | 39.4 |
| member 19 | | | | | |
| Photosensitive | PAR-1 | E-1 | 100 | 30 | 23.1 |
| member 20 | | | | | |
| Photosensitive | PAR-1 | E-1 | 100 | 55 | 35.5 |
| member 21 | | | | | |
| Photosensitive | PAR-1 | E-1 | 100 | 23 | 18.7 |
| member 22 | | | | | |
| Photosensitive | PAR-1 | E-1 | 100 | 18 | 15.3 |
| member 23 | | | | | |
| Photosensitive | PAR-1 | E-1 | 100 | 70 | 41.2 |
| member 24 | | | | | |
| Photosensitive | PAR-1 | E-1 | 100 | 80 | 44.4 |
| member 25 | | | | | |
| Photosensitive | PAR-17 | E-1 | 100 | 40 | 28.6 |
| member 26 | | | | | |
| Photosensitive | PAR-18 | E-1 | 100 | 40 | 28.6 |
| member 27 | | | | | |
| Photosensitive | PAR-19 | E-1 | 100 | 40 | 28.6 |
| member 28 | | | | | |

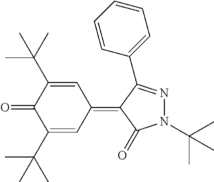 [SMILES: CC(C)(C)C1=CC(=C2C(=O)N(C(C)(C)C)N=C2c2ccccc2)C=C(C(C)(C)C)C1=O]

### Production of Developing Roller 1

A shaft with electroless nickel plating (made of SUM22, diameter: 10 mm, length: 275 mm) was washed with ethanol, and the surface of the shaft was coated with a silicone-based primer (trade name: “Primer No. 16”, manufactured by Shin-Etsu Chemical Co., Ltd.). The primer-treated shaft was baked at 150° C. for 10 minutes in a gear oven and subsequently cooled at room temperature for 30 minutes or more, to form a primer layer on the outer circumferential surface of the shaft.

Subsequently, a silicone rubber composition for forming an elastic layer was prepared in the following manner. First, the following materials were prepared.

### Formation of Elastic Layer

The following materials were prepared.
Dimethylpolysiloxane capped at both ends with dimethylvinylsiloxy groups (degree of polymerization: 300): 100 parts by mass
Hydrophobized fumed silica having BET specific surface area of 110 m²/g (trade name: “R-972”, manufactured by NIPPON AEROSIL CO., LTD.): 1 part by mass
Diatomaceous earth having average particle size of 6 μm and bulk density of 0.25 g/cm³ (trade name: “Oplite W-3005S”, manufactured by Chuo Silika Co., Ltd.): 40 parts by mass
Acetylene black (trade name: “DENKA BLACK HS-100”, manufactured by Denka Company Limited): 5 parts by mass

These were placed into a planetary mixer, stirred for 30 minutes, and then passed once through a three-roll mill.

This was returned to the planetary mixer.

Subsequently, the following materials were prepared.
Methylhydrogenpolysiloxane having Si—H groups at both ends and side chains (degree of polymerization: 17, amount of Si—H: 0.0060 mol/g): 2.1 parts by mass
Ethynyl cyclohexanol: 0.1 parts by mass
Platinum catalyst (Pt concentration: 1%): 0.1 parts by mass

These were added to the planetary mixer and kneaded and degassed for 15 minutes, to prepare an addition-curable liquid conductive silicone rubber composition. The prepared addition-curable liquid conductive silicone rubber composition was molded onto the outer circumferential surface of the shaft by liquid injection molding. This molded body was polished to form an elastic layer.

### Formation of Surface Layer

The following materials were prepared.
Polyol (polyester polyol, trade name: “NIPPOLLAN 139”, manufactured by Nippon Polyurethane Industry Co., Ltd.): 30 parts by mass
Polyisocyanate (trade name: “CORONATE-LJ”, manufactured by Nippon Polyurethane Industry Co., Ltd.): 10 parts by mass
Dibutyl tin dilaurate (manufactured by Tokyo Chemical Industry Co., Ltd.): 0.03 parts by mass
Small-diameter silica (average particle size: 4.4 μm, trade name: “ACEMATT OK-607”, manufactured by Evonik Degussa GmbH): 4 parts by mass
Conductivity-imparting agent (trade name: “EC600JD”, manufactured by Lion Corporation): 5 parts by mass
Tributylmethylammonium=bis(trifluoromethanesulfonyl)imide having, as cation, structure represented by formula (I-1) below: 1 part by mass

These were mixed to obtain a urethane resin composition.

Subsequently, the urethane resin composition was applied to the outer circumferential surface of the elastic layer by spray coating, heated at 160° C. for 30 minutes to form a surface layer; and the developing roller 1 had a layer thickness of 13 μm. In this way, the developing roller 1 was produced.

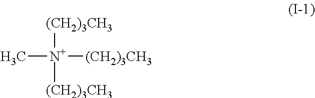

### Production of Developing Rollers 2 to 21

The developing rollers 2 to 21 were formed as with the developing roller 1 except that the ionic conductive agent was changed as described in Table 3.

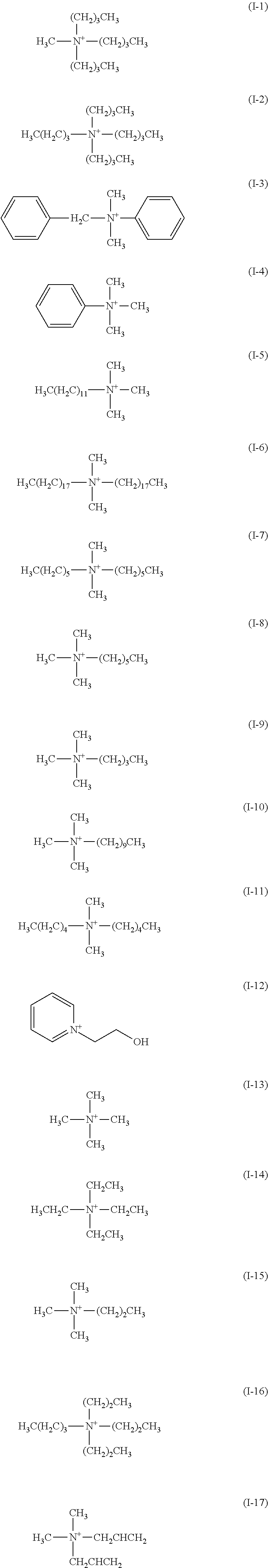

TABLE 3

| | Cation | Anion |
|---|---|---|
| Developing roller 1 | I-1 | TFSI⁻ |
| Developing roller 2 | I-1 | Cl⁻ |
| Developing roller 3 | I-1 | OH⁻ |
| Developing roller 4 | I-1 | Br⁻ |
| Developing roller 5 | I-1 | I⁻ |
| Developing roller 6 | I-2 | TFSI⁻ |
| Developing roller 7 | I-3 | TFSI⁻ |
| Developing roller 8 | I-4 | TFSI⁻ |
| Developing roller 9 | I-5 | TFSI⁻ |
| Developing roller 10 | I-6 | TFSI⁻ |
| Developing roller 11 | I-7 | TFSI⁻ |
| Developing roller 12 | I-8 | TFSI⁻ |
| Developing roller 13 | I-9 | TFSI⁻ |
| Developing roller 14 | I-10 | TFSI⁻ |
| Developing roller 15 | I-11 | TFSI⁻ |
| Developing roller 16 | I-12 | TFSI⁻ |
| Developing roller 17 | I-13 | TFSI⁻ |
| Developing roller 18 | I-14 | TFSI⁻ |
| Developing roller 19 | I-15 | TFSI⁻ |
| Developing roller 20 | I-16 | TFSI⁻ |
| Developing roller 21 | I-17 | TFSI⁻ |

### Evaluations

### Evaluation of Bleeding (Evaluation (1))

Whether or not bleeding from a conductive roller occurred during long-term use was determined. First, a 10 mm wide sheet material obtained by forming the same photosensitive layer as in the above-described photosensitive member by coating on a PET film sheet was prepared; the developing roller and the surface having the photosensitive layer formed by coating on the PET film sheet were brought into contact with each other (applying a 500 g load to each end of the shaft core body), and the assembly was left for 2 months in an environment of 40° C./95% R.H.; the surface of the PET film sheet was observed using an optical microscope (10×). Whether or not the bled substance from the conductive roller adhered to the PET film sheet was observed, and evaluated based on the following criteria.

### Evaluation Criteria

A: No bleeding observed on the surface of the PET sheet.
B: Minor bleeding observed on part of the surface of the PET sheet.
C: Noticeable bleeding observed on the surface of the PET sheet.

### Evaluation of Image Failure (Evaluation (2))

The above-described photosensitive member and developing roller were brought into contact with each other at a surface pressure of 3.5 g/mm² at the contact area, and left in an environment at 40° C. and 95% relative humidity for 1 month. Subsequently, they were incorporated into an electrophotographic apparatus (manufactured by BROTHER INDUSTRIES, LTD., HI-L9470), a printed sample with a halftone image formed on the front was output, and whether or not image defects due to photosensitive member contamination (band-shaped image failure) were present was evaluated on the basis of the following criteria.

### Evaluation Criteria

A: No band-shaped unevenness observed.
B: Slight band-shaped unevenness observed.
C: Band-shaped unevenness observed at positions corresponding to the rotation pitch of the photosensitive member.
D: Prominent band-shaped unevenness observed.
   Evaluation of Image Failure after Durability Testing (Evaluation (3))

The above-described photosensitive member and developing roller were brought into contact with each other at a surface pressure of 3.5 g/mm² at the contact area and left in an environment of 40° C. and 95% relative humidity for 1 month. Subsequently, they were incorporated into an electrophotographic apparatus (manufactured by BROTHER INDUSTRIES, LTD., Hl-L9470) and subjected to a sheet passing durability test. In the sheet passing durability test, the apparatus was operated in intermittent mode, where it stopped after every two printed pages of text images with a 2% coverage rate, resulting in a total of 5000 pages of image output. Then, one sample image (solid image with 100% print density) was output for image evaluation both at the start of the sheet passing durability test and after the completion of the 5000 pages of image output; whether or not the image density was obtained was evaluated on the basis of the following criteria.

### Evaluation Criteria

A: No low density observed.
B: Slight low density observed.
C: Prominent low density observed.

### Example 1

A photosensitive layer having the same configuration as in the photosensitive member 1 produced above was formed by coating on a PET film sheet, brought into contact with the developing roller 1, and subjected to Evaluation (1). In addition, the photosensitive member 1 and the developing roller 1 were subjected to Evaluation (2) and Evaluation (3). The results will be described in Table 4.

### Examples 2 to 38

Evaluations were performed as in Example 1 except that the photosensitive member and the developing roller were changed as described in Table 4. The results will be described in Table 4.

TABLE 4

| | Photosensitive | Developing | Evalua- | Evalua- | Evalua- |
|---|---|---|---|---|---|
| | member | roller | tion (1) | tion (2) | tion (3) |
| Example 1 | Photosensitive | Developing | A | A | A |
| | member 1 | roller 1 | | | |
| Example 2 | Photosensitive | Developing | A | A | A |
| | member 1 | roller 2 | | | |
| Example 3 | Photosensitive | Developing | A | A | A |
| | member 1 | roller 3 | | | |
| Example 4 | Photosensitive | Developing | A | A | A |
| | member 1 | roller 4 | | | |
| Example 5 | Photosensitive | Developing | A | A | A |
| | member 2 | roller 5 | | | |
| Example 6 | Photosensitive | Developing | A | A | B |
| | member 3 | roller 1 | | | |
| Example 7 | Photosensitive | Developing | A | A | A |
| | member 4 | roller 1 | | | |
| Example 8 | Photosensitive | Developing | A | A | A |
| | member 5 | roller 1 | | | |
| Example 9 | Photosensitive | Developing | A | A | B |
| | member 6 | roller 1 | | | |
| Example | Photosensitive | Developing | A | A | B |
| 10 | member 7 | roller 1 | | | |
| Example | Photosensitive | Developing | A | A | B |
| 11 | member 8 | roller 1 | | | |
| Example | Photosensitive | Developing | A | A | A |
| 12 | member 9 | roller 1 | | | |
| Example | Photosensitive | Developing | A | A | B |
| 13 | member 10 | roller 1 | | | |
| Example | Photosensitive | Developing | A | A | B |
| 14 | member 11 | roller 1 | | | |
| Example | Photosensitive | Developing | A | A | B |
| 15 | member 12 | roller 1 | | | |
| Example | Photosensitive | Developing | A | A | B |
| 16 | member 13 | roller 1 | | | |
| Example | Photosensitive | Developing | A | A | B |
| 17 | member 14 | roller 1 | | | |
| Example | Photosensitive | Developing | A | A | B |
| 18 | member 15 | roller 1 | | | |
| Example | Photosensitive | Developing | A | A | B |
| 19 | member 16 | roller 1 | | | |
| Example | Photosensitive | Developing | A | A | B |
| 20 | member 17 | roller 1 | | | |
| Example | Photosensitive | Developing | B | B | B |
| 21 | member 1 | roller 6 | | | |
| Example | Photosensitive | Developing | B | C | B |
| 22 | member 1 | roller 7 | | | |
| Example | Photosensitive | Developing | B | C | B |
| 23 | member 1 | roller 8 | | | |
| Example | Photosensitive | Developing | B | B | B |
| 24 | member 1 | roller 9 | | | |
| Example | Photosensitive | Developing | B | B | B |
| 25 | member 1 | roller 10 | | | |
| Example | Photosensitive | Developing | B | A | A |
| 26 | member 1 | roller 11 | | | |
| Example | Photosensitive | Developing | B | B | A |
| 27 | member 1 | roller 12 | | | |
| Example | Photosensitive | Developing | B | B | A |
| 28 | member 1 | roller 13 | | | |
| Example | Photosensitive | Developing | B | B | A |
| 29 | member 1 | roller 14 | | | |
| Example | Photosensitive | Developing | B | A | A |
| 30 | member 1 | roller 15 | | | |
| Example | Photosensitive | Developing | A | A | A |
| 31 | member 18 | roller 1 | | | |
| Example | Photosensitive | Developing | A | A | A |
| 32 | member 19 | roller 1 | | | |
| Example | Photosensitive | Developing | A | A | A |
| 33 | member 20 | roller 1 | | | |
| Example | Photosensitive | Developing | A | A | A |
| 34 | member 21 | roller 1 | | | |
| Example | Photosensitive | Developing | A | A | B |
| 35 | member 22 | roller 1 | | | |
| Example | Photosensitive | Developing | A | B | B |
| 36 | member 23 | roller 1 | | | |
| Example | Photosensitive | Developing | A | B | B |
| 37 | member 24 | roller 1 | | | |
| Example | Photosensitive | Developing | A | B | C |
| 38 | member 25 | roller 1 | | | |

### Comparative Examples 1 to 9

Evaluations were performed as in Example 1 except that the photosensitive member and the developing roller were changed as described in Table 5. The results will be described in Table 5. In all of Comparative Examples, bleeding and defective images were noticeable.

TABLE 5

| | Photosensitive | Developing | Evalua- | Evalua- | Evalua- |
|---|---|---|---|---|---|
| | member | roller | tion (1) | tion (2) | tion (3) |
| Comparative | Photosensitive | Developing | C | D | C |
| Example 1 | member 26 | roller 1 | | | |
| Comparative | Photosensitive | Developing | C | D | C |
| Example 2 | member 27 | roller 1 | | | |
| Comparative | Photosensitive | Developing | C | D | C |
| Example 3 | member 28 | roller 1 | | | |
| Comparative | Photosensitive | Developing | B | D | C |
| Example 4 | member 1 | roller 16 | | | |
| Comparative | Photosensitive | Developing | C | C | C |
| Example 5 | member 1 | roller 17 | | | |
| Comparative | Photosensitive | Developing | C | C | C |
| Example 6 | member 1 | roller 18 | | | |
| Comparative | Photosensitive | Developing | C | C | C |
| Example 7 | member 1 | roller 19 | | | |
| Comparative | Photosensitive | Developing | C | C | C |
| Example 8 | member 1 | roller 20 | | | |
| Comparative | Photosensitive | Developing | C | C | C |
| Example 9 | member 1 | roller 21 | | | |

The present disclosure can provide an electrophotographic apparatus that can suppress bleeding of an ionic conductive agent, suppress image failure and deterioration of characteristics due to the bleeding, and form a high-quality electrophotographic image.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-182208, filed Oct. 17, 2024, which is hereby incorporated by reference herein in its entirety.

What is claimed is:

1. An electrophotographic apparatus comprising:
an electrophotographic photosensitive member; and
a contact developing device including toner and a developing roller and configured to bring the developing roller carrying the toner into contact with the electrophotographic photosensitive member to develop an electrostatic latent image formed on a surface of the electrophotographic photosensitive member,
wherein the electrophotographic photosensitive member includes a surface layer containing a binder resin and an electron transport agent,
wherein the surface layer contains a polyester resin as the binder resin,
wherein the polyester resin includes a structural unit represented by formula (P-1) and a structural unit represented by formula (P-2), and
wherein the developing roller includes a surface layer containing a compound represented by formula (1): 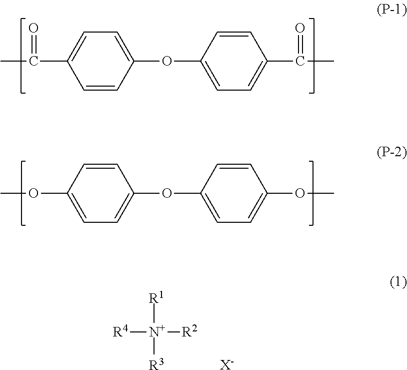
in the formula (1), R¹ to R⁴ represent a hydrocarbon group having 1 or more and 18 or less carbon atoms and at least one of R¹ to R⁴ represents a hydrocarbon group having 4 or more and 18 or less carbon atoms, and X⁻ represents an anion.

2. The electrophotographic apparatus according to claim 1, wherein the polyester resin further includes a structural unit represented by formula (P-3) and a structural unit represented by formula (P-4):

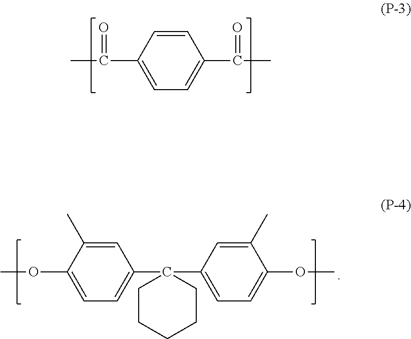

3. The electrophotographic apparatus according to claim 1, wherein the electron transport agent includes a compound represented by formula (E-1):

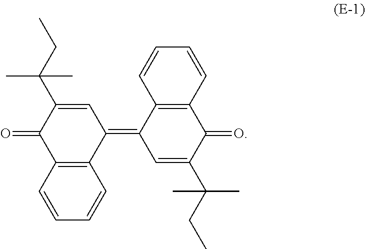 [SMILES: CCC(C)(C)C1=C/C(=C2/C=C(C(C)(C)CC)C(=O)c3ccccc32)c2ccccc2C1=O]

4. The electrophotographic apparatus according to claim 1, wherein a compound having the smallest SP value in the electron transport agent has the SP value defined as SP_{E} (J/cm³)^{0.5}, a cation having the largest SP value in the cation in the formula (1) has the SP value defined as SP_{I} (J/cm³)^{0.5}, and SP_{E} and SP_{I} satisfy formula (2):
$${SP}_{E} - {SP}_{I} \geq 5.2 \qquad ( 2 )$$

5. The electrophotographic apparatus according to claim 1, wherein at least two of R¹ to R⁴ in formula (1) represent a hydrocarbon group having 4 or more and 18 or less carbon atoms.

6. The electrophotographic apparatus according to claim 1, wherein the compound represented by formula (1) contains a cation represented by formula (I-1):

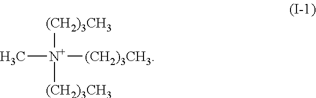

7. The electrophotographic apparatus according to claim 1, wherein, in the surface layer of the electrophotographic photosensitive member, a content of the binder resin defined as B parts by mass and a content of the electron transport agent defined as E parts by mass satisfy formula (3):
$$20 \leq E / ( E + B ) \times 100 \leq 40 \qquad ( 3 )$$

8. The electrophotographic apparatus according to claim 1, wherein the surface layer of the electrophotographic photosensitive member is a single-layer photosensitive layer containing a hole transport agent, a charge generation agent, the electron transport agent, and the binder resin.

9. A process cartridge comprising:
an electrophotographic photosensitive member; and
a contact developing device including toner and a developing roller and configured to bring the developing roller carrying the toner into contact with the electrophotographic photosensitive member to develop an electrostatic latent image formed on a surface of the electrophotographic photosensitive member,
the process cartridge collectively supporting the electrophotographic photosensitive member and the contact developing device, and being attachable to and detachable from a body of an electrophotographic apparatus,
wherein the electrophotographic photosensitive member includes a surface layer containing a binder resin and an electron transport agent,
wherein the surface layer contains a polyester resin as the binder resin,
wherein the polyester resin includes a structural unit represented by formula (P-1) and a structural unit represented by formula (P-2), and
wherein the developing roller includes a surface layer containing a compound represented by formula (1): 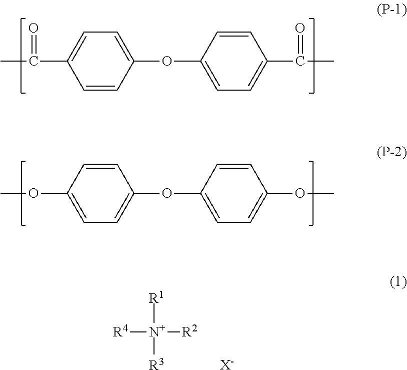
in the formula (1), R¹ to R⁴ represent a hydrocarbon group having 1 or more and 18 or less carbon atoms and at least one of R¹ to R⁴ represents a hydrocarbon group having 4 or more and 18 or less carbon atoms, and X⁻ represents an anion.

10. The process cartridge according to claim 9, collectively supporting:
the electrophotographic photosensitive member;
a charging unit configured to charge the surface of the electrophotographic photosensitive member; and
the contact developing device,
wherein the process cartridge is attachable to and detachable from the body of the electrophotographic apparatus.
